(19) United States
(12) Patent Application Publication
(10) Pub. No.: US 2019/0331171 A1
(43) Pub. Date: Oct. 31, 2019

(54) RECIPROCATION-DAMPENING DRIVE SHAFT ASSEMBLY

(71) Applicant: Ironside, LLC, Conroe, TX (US)

(72) Inventor: Daniele Molaro TOPPAZZINI, Brookshire, TX (US)

(21) Appl. No.: 15/996,830

(22) Filed: Jun. 4, 2018

Related U.S. Application Data
(60) Provisional application No. 62/663,411, filed on Apr. 27, 2018.

(51) Int. Cl. F16D 3/22; F16D 3/06; E21B 4/00; F16C 3/02

(52) U.S. Cl. CPC F16D 3/22; F16D 3/065; F16F 1/3605; F16C 3/02; E21B 4/00; E21B 4/003

(57) ABSTRACT

Mechanical stresses caused by jarring axial loads reduce the operational life of conventional drive shaft assemblies, increase non-productive downtime, and increase costs. A reciprocation-dampening drive shaft assembly is disclosed that allows the drive shaft to rotate and withstand axial loads, as well as vibration, without slippage or damage to the adapters of the drive shaft assembly, thereby extending productive uptime of drilling operations. The reciprocation-dampening drive shaft assembly includes first and second reciprocation-dampening adapters, first and second floating seats, first and second drive shaft portions, first and second floating rings, first and second reciprocation-dampening adapter caps with dampener inserts, and first and second boots. The spheroidal ends of the first and second drive shaft portions have limited axial freedom of motion while rotating without damaging the adapters. In addition, the dampener insert included with the first and second reciprocation-dampening adapter caps reduce vibration.

### BACKGROUND OF THE INVENTION

A conventional drilling rig is used to drill a wellbore that provides access to a subsurface formation. The wellbore may include one or more straight and/or directional sections. In addition, a drilling rig may be used to stimulate an already existing well to gain access to more remote subsurface formations. Hydraulic fracturing is an example of an effective well-stimulation technique in which a geologic formation is hydraulically fractured by a high-pressure fluid to extract the hydrocarbon deposits disposed therein.

During conventional drilling operations, a top drive, or rotary table, system is used to rotate a drill string and a drill bit, where the rotation is provided from the surface. However, once the well plan kicks off on a directional section, where the inclination angle is non-zero, rotation typically cannot be provided from the surface. As such, a hydraulic system may be used to rotate a drill bit, where the rotation is provided downhole using hydrostatic pressure. A conventional hydraulic drilling system includes a hydraulic power section, sometimes referred to as a mud motor, which is disposed downhole to convert hydraulic energy from drilling fluid and/or drilling mud into mechanical energy that rotates a drill bit. A conventional mud motor uses a Moineau progressive cavity positive displacement pump system that typically includes a helical rotor inserted into a double helix stator. The interference fit between the rotor and the stator forms a number of sealed cavities. As fluid enters a cavity formed at an inlet, hydrostatic pressure forces the fluid through the cavities toward an outlet and rotates the rotor eccentrically within the stator. The eccentric rotation of the rotor is transferred to the drill bit by a drive shaft assembly that seeks to reduce or eliminate eccentricity while transferring torque to the drill bit.

### BRIEF SUMMARY OF THE INVENTION

According to one aspect of one or more embodiments of the present invention, a reciprocation-dampening drive shaft assembly includes a first reciprocation-dampening adapter having a connection end and a cylindrical adapter portion. The cylindrical adapter portion includes a recessed inner aperture having a first diameter, a recessed inner aperture having a second diameter and a plurality of semispheroidal recessed portions, and a first adapter threaded end. A first plurality of spring washers are disposed within the recessed inner aperture having the first diameter of the first reciprocation-dampening adapter. A first floating seat is disposed within the recessed inner aperture having the first diameter of the first reciprocation-dampening adapter on a spring loaded side of the first plurality of spring washers. The first floating seat includes a spheroidal cap indentation configured to receive a portion of a spheroidal end of a first drive shaft portion. The first drive shaft portion includes the spheroidal end, a cylindrical shaft portion, and a shaft threaded end. The spheroidal end includes a plurality of ball cap indentations disposed about its outer surface. A first floating ring includes a plurality of semispheroidal recessed portions. The plurality of semispheroidal recessed portions of the first reciprocation-dampening adapter are configured to receive a portion of a first plurality of spheroidal balls partially disposed within the plurality of ball cap indentations of the spheroidal end of the first drive shaft portion and the plurality of semispheroidal recessed portions of the first floating ring are configured to receive a portion of the first plurality of spheroidal balls partially disposed within the plurality of ball cap indentations of the spheroidal end of the first drive shaft portion. A first plurality of spring washers are disposed within the recessed inner aperture having the second diameter of the first reciprocation-dampening adapter. A first reciprocation-dampening adapter cap includes a recessed dampener aperture configured to receive a first dampener insert and a first adapter cap threaded end configured to removably connect to the first adapter threaded end of the first reciprocation-dampening adapter. A first boot is configured to seal the first reciprocation-dampening adapter cap and the cylindrical shaft portion of the first drive shaft portion.

Other aspects of the present invention will be apparent from the following description and claims.

### BRIEF DESCRIPTION OF THE DRAWINGS

FIG. 1 shows a schematic view of a hydraulic drilling system.

FIG. 2A shows a top-facing perspective view of a conventional drive shaft assembly used as part of a hydraulic drilling system.

FIG. 2B shows an exploded view of the conventional drive shaft assembly.

FIG. 2C shows a perspective view of a worn-out adapter of a conventional drive shaft assembly.

FIG. 3A shows a top-facing perspective view of a reciprocation-dampening drive shaft assembly in accordance with one or more embodiments of the present invention.

FIG. 3B shows a bottom-facing perspective view of the reciprocation-dampening drive shaft assembly in accordance with one or more embodiments of the present invention.

FIG. 3C shows a front elevation view of the reciprocation-dampening drive shaft assembly in accordance with one or more embodiments of the present invention.

FIG. 3D shows a side elevation view of the reciprocation-dampening drive shaft assembly in accordance with one or more embodiments of the present invention.

FIG. 3E shows a top plan view of the reciprocation-dampening drive shaft assembly in accordance with one or more embodiments of the present invention.

FIG. 3F shows a bottom plan view of the reciprocation-dampening drive shaft assembly in accordance with one or more embodiments of the present invention.

FIG. 4 shows an exploded view of a reciprocation-dampening drive shaft assembly in accordance with one or more embodiments of the present invention.

FIG. 5 shows a cross-sectional view of a reciprocation-dampening drive shaft assembly in accordance with one or more embodiments of the present invention.

FIG. 6 shows a detailed cross-sectional view of an assembled portion of a first reciprocation-dampening adapter of a reciprocation-dampening drive shaft assembly in accordance with one or more embodiments of the present invention.

FIG. 7 shows a detailed cross-sectional view of an assembled portion of a second reciprocation-dampening adapter of a reciprocation-dampening drive shaft assembly in accordance with one or more embodiments of the present invention.

FIG. 8A shows a top-facing perspective view of a first reciprocation-dampening adapter of a reciprocation-dampening drive shaft assembly in accordance with one or more embodiments of the present invention.

FIG. 8B shows a side elevation view of the first reciprocation-dampening adapter of the reciprocation-dampening drive shaft assembly in accordance with one or more embodiments of the present invention.

FIG. 8C shows a top plan view of the first reciprocation-dampening adapter of the reciprocation-dampening drive shaft assembly in accordance with one or more embodiments of the present invention.

FIG. 8D shows a bottom plan view of the first reciprocation-dampening adapter of the reciprocation-dampening drive shaft assembly in accordance with one or more embodiments of the present invention.

FIG. 8E shows a bottom-facing perspective view of the first reciprocation-dampening adapter of the reciprocation-dampening drive shaft assembly in accordance with one or more embodiments of the present invention.

FIG. 9A shows a top-facing perspective view of a plurality of spring washers with a first inner diameter of a reciprocation-dampening drive shaft assembly in accordance with one or more embodiments of the present invention.

FIG. 9B shows a side elevation view of the plurality of spring washers with the first inner diameter of the reciprocation-dampening drive shaft assembly in accordance with one or more embodiments of the present invention.

FIG. 9C shows a top plan view of the plurality of spring washers with the first inner diameter of the reciprocation-dampening drive shaft assembly in accordance with one or more embodiments of the present invention.

FIG. 9D shows a bottom plan view of the plurality of spring washers with the first inner diameter of the reciprocation-dampening drive shaft assembly in accordance with one or more embodiments of the present invention.

FIG. 9E shows a bottom-facing perspective view of the plurality of spring washers with the first inner diameter of the reciprocation-dampening drive shaft assembly in accordance with one or more embodiments of the present invention.

FIG. 10A shows a top-facing perspective view of a floating seat of a reciprocation-dampening drive shaft assembly in accordance with one or more embodiments of the present invention.

FIG. 10B shows a side elevation view of the floating seat of the reciprocation-dampening drive shaft assembly in accordance with one or more embodiments of the present invention.

FIG. 10C shows a top plan view of the floating seat of the reciprocation-dampening drive shaft assembly in accordance with one or more embodiments of the present invention.

FIG. 10D shows a bottom plan view of the floating seat of the reciprocation-dampening drive shaft assembly in accordance with one or more embodiments of the present invention.

FIG. 10E shows a bottom-facing perspective view of the floating seat of the reciprocation-dampening drive shaft assembly in accordance with one or more embodiments of the present invention.

FIG. 11A shows a top-facing perspective view of a first drive shaft portion of a reciprocation-dampening drive shaft assembly in accordance with one or more embodiments of the present invention.

FIG. 11B shows a side elevation view of the first drive shaft portion of the reciprocation-dampening drive shaft assembly in accordance with one or more embodiments of the present invention.

FIG. 11C shows a top plan view of the first drive shaft portion of the reciprocation-dampening drive shaft assembly in accordance with one or more embodiments of the present invention.

FIG. 11D shows a bottom plan view of the first drive shaft portion of the reciprocation-dampening drive shaft assembly in accordance with one or more embodiments of the present invention.

FIG. 11E shows a bottom-facing perspective view of the first drive shaft portion of the reciprocation-dampening drive shaft assembly in accordance with one or more embodiments of the present invention.

FIG. 12A shows a top-facing perspective view of a floating ring of a reciprocation-dampening drive shaft assembly in accordance with one or more embodiments of the present invention.

FIG. 12B shows a side elevation view of the floating ring of the reciprocation-dampening drive shaft assembly in accordance with one or more embodiments of the present invention.

FIG. 12C shows a top plan view of the floating ring of the reciprocation-dampening drive shaft assembly in accordance with one or more embodiments of the present invention.

FIG. 12D shows a bottom plan view of the floating ring of the reciprocation-dampening drive shaft assembly in accordance with one or more embodiments of the present invention.

FIG. 12E shows a bottom-facing perspective view of the floating ring of the reciprocation-dampening drive shaft assembly in accordance with one or more embodiments of the present invention.

FIG. 13A shows a top-facing perspective view of a plurality of spring washers with a second inner diameter of a reciprocation-dampening drive shaft assembly in accordance with one or more embodiments of the present invention.

FIG. 13B shows a side elevation view of the plurality of spring washers with the second inner diameter of the reciprocation-dampening drive shaft assembly in accordance with one or more embodiments of the present invention.

FIG. 13C shows a top plan view of the plurality of spring washers with the second inner diameter of the reciprocation-dampening drive shaft assembly in accordance with one or more embodiments of the present invention.

FIG. 13D shows a bottom plan view of the plurality of spring washers with the second inner diameter of the reciprocation-dampening drive shaft assembly in accordance with one or more embodiments of the present invention.

FIG. 13E shows a bottom-facing perspective view of the plurality of spring washers with the second inner diameter of the reciprocation-dampening drive shaft assembly in accordance with one or more embodiments of the present invention.

FIG. 14A shows a top-facing perspective view of a reciprocation-dampening adapter cap of a reciprocation-dampening drive shaft assembly in accordance with one or more embodiments of the present invention.

FIG. 14B shows a side elevation view of the reciprocation-dampening adapter cap of the reciprocation-dampening drive shaft assembly in accordance with one or more embodiments of the present invention.

FIG. 14C shows a top plan view of the reciprocation-dampening adapter cap of the reciprocation-dampening drive shaft assembly in accordance with one or more embodiments of the present invention.

FIG. 14D shows a bottom plan view of the reciprocation-dampening adapter cap of the reciprocation-dampening drive shaft assembly in accordance with one or more embodiments of the present invention.

FIG. 14E shows a bottom-facing perspective view of the reciprocation-dampening adapter cap of the reciprocation-dampening drive shaft assembly in accordance with one or more embodiments of the present invention.

FIG. 15A shows a top-facing perspective view of a dampener insert of a reciprocation-dampening drive shaft assembly in accordance with one or more embodiments of the present invention.

FIG. 15B shows a side elevation view of the dampener insert of the reciprocation-dampening drive shaft assembly in accordance with one or more embodiments of the present invention.

FIG. 15C shows a top plan view of the dampener insert of the reciprocation-dampening drive shaft assembly in accordance with one or more embodiments of the present invention.

FIG. 15D shows a bottom plan view of the dampener insert of the reciprocation-dampening drive shaft assembly in accordance with one or more embodiments of the present invention.

FIG. 15E shows a bottom-facing perspective view of the dampener insert of the reciprocation-dampening drive shaft assembly in accordance with one or more embodiments of the present invention.

FIG. 16A shows a top-facing perspective view of a boot of a reciprocation-dampening drive shaft assembly in accordance with one or more embodiments of the present invention.

FIG. 16B shows a side elevation view of the boot of the reciprocation-dampening drive shaft assembly in accordance with one or more embodiments of the present invention.

FIG. 16C shows a top plan view of the boot of the reciprocation-dampening drive shaft assembly in accordance with one or more embodiments of the present invention.

FIG. 16D shows a bottom plan view of the boot of the reciprocation-dampening drive shaft assembly in accordance with one or more embodiments of the present invention.

FIG. 16E shows a bottom-facing perspective view of the boot of the reciprocation-dampening drive shaft assembly in accordance with one or more embodiments of the present invention.

FIG. 17A shows a top-facing perspective view of a drive shaft joint of a reciprocation-dampening drive shaft assembly in accordance with one or more embodiments of the present invention.

FIG. 17B shows a side elevation view of the drive shaft joint of the reciprocation-dampening drive shaft assembly in accordance with one or more embodiments of the present invention.

FIG. 17C shows a top plan view of the drive shaft joint of the reciprocation-dampening drive shaft assembly in accordance with one or more embodiments of the present invention.

FIG. 17D shows a bottom plan view of the drive shaft joint of the reciprocation-dampening drive shaft assembly in accordance with one or more embodiments of the present invention.

FIG. 17E shows a bottom-facing perspective view of the drive shaft joint of the reciprocation-dampening drive shaft assembly in accordance with one or more embodiments of the present invention.

FIG. 18A shows a top-facing perspective view of a second drive shaft portion of a reciprocation-dampening drive shaft assembly in accordance with one or more embodiments of the present invention.

FIG. 18B shows a side elevation view of the second drive shaft portion of the reciprocation-dampening drive shaft assembly in accordance with one or more embodiments of the present invention.

FIG. 18C shows a top plan view of the second drive shaft portion of the reciprocation-dampening drive shaft assembly in accordance with one or more embodiments of the present invention.

FIG. 18D shows a bottom plan view of the second drive shaft portion of the reciprocation-dampening drive shaft assembly in accordance with one or more embodiments of the present invention.

FIG. 18E shows a bottom-facing perspective view of the second drive shaft portion of the reciprocation-dampening drive shaft assembly in accordance with one or more embodiments of the present invention.

FIG. 19A shows a top-facing perspective view of a second reciprocation-dampening adapter of a reciprocation-dampening drive shaft assembly in accordance with one or more embodiments of the present invention.

FIG. 19B shows a front elevation view of the second reciprocation-dampening adapter of the reciprocation-dampening drive shaft assembly in accordance with one or more embodiments of the present invention.

FIG. 19C shows a side elevation view of the second reciprocation-dampening adapter of the reciprocation-dampening drive shaft assembly in accordance with one or more embodiments of the present invention.

FIG. 19D shows a top plan view of the second reciprocation-dampening adapter of the reciprocation-dampening drive shaft assembly in accordance with one or more embodiments of the present invention.

FIG. 19E shows a bottom plan view of the second reciprocation-dampening adapter of the reciprocation-dampening drive shaft assembly in accordance with one or more embodiments of the present invention.

FIG. 19F shows a bottom-facing perspective view of the second reciprocation-dampening adapter of the reciprocation-dampening drive shaft assembly in accordance with one or more embodiments of the present invention.

FIG. 20A shows a top-facing perspective view of a grease injection nipple of a reciprocation-dampening drive shaft assembly in accordance with one or more embodiments of the present invention.

FIG. 20B shows a side elevation view of the grease injection nipple of the reciprocation-dampening drive shaft assembly in accordance with one or more embodiments of the present invention.

FIG. 20C shows a top plan view of the grease injection nipple of the reciprocation-dampening drive shaft assembly in accordance with one or more embodiments of the present invention.

FIG. 20D shows a bottom plan view of the grease injection nipple of the reciprocation-dampening drive shaft assembly in accordance with one or more embodiments of the present invention.

FIG. 20E shows a bottom-facing perspective view of the grease injection nipple of the reciprocation-dampening drive shaft assembly in accordance with one or more embodiments of the present invention.

FIG. 21 shows a bottomhole assembly including a reciprocation-dampening drive shaft assembly in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

For the purpose of this disclosure, spheroid (or spheroidal) means spherical or approximately spherical, semispheroid (or semispheroidal) means a portion of a spheroid, and cap means a portion of a spheroid cut off by a bisecting plane.

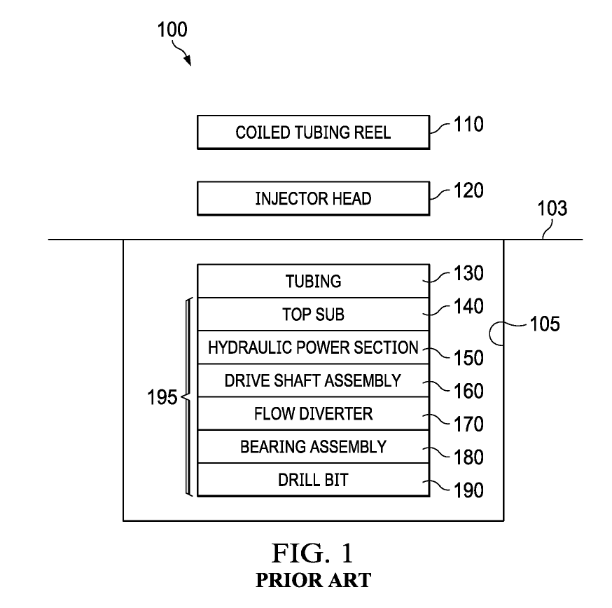

FIG. 1 shows a schematic view of a hydraulic drilling system, or rig, 100. For purposes of illustration only, a coiled tubing rig 100 is depicted in FIG. 1. Coiled tubing rig 100 may be used in various applications including, for example, drilling operations, well stimulation including hydraulic fracturing, well intervention, and repair and remediation work. One of ordinary skill in the art will recognize that other types of hydraulic drilling systems (not shown) may be used for such purposes.

Coiled tubing rig 100 includes a sufficient length of tubing 130 spooled on a coiled tubing reel 110 that is disposed above the surface 103. A first end (not shown) of tubing 130 remains disposed above the surface 103 and is in fluid communication with a fluid source (not shown) that provides drilling fluid and/or drilling mud (not shown) under pressure. A second end (not shown) of tubing 130 is disposed downhole 105 and is in fluid communication with a bottom hole assembly (“BHA”) 195 that receives the drilling fluid and/or drilling mud (not shown) provided from the surface 103. An injector head 120 may be used to push and/or pull tubing 130 into or out of wellbore 105 or position BHA 195 in a desired location.

BHA 195 typically includes a top sub 140, a hydraulic power section 150, a drive shaft assembly 160, a flow diverter 170, a bearing assembly 180, and a drill bit 190. Top sub 140 is a tubular connector that provides a fluid connection between tubing 130 and hydraulic power section 150. Hydraulic power section, or mud motor, 150 uses the hydrostatic pressure of the drilling fluid and/or drilling mud (not shown) to provide eccentric rotation to drive shaft assembly 160. One of ordinary skill in the art will recognize that hydraulic power section 150 may vary based on one or more design characteristics such as, for example, the number of stages (not shown), the lobe ratio (not shown), the external diameter (not shown), the design of the rotor, and the design of the stator. In addition, one of ordinary skill in the art will also recognize that hydraulic power section 150 may vary in the rotational speed, torque, or amount of eccentricity it produces. Drive shaft assembly 160 reduces or eliminates the eccentricity of hydraulic power section 150 and provides substantially concentric rotation to drill bit 190 via bearing assembly 180 and flow diverter 170. In this way, drive shaft assembly 160 transfers torque from hydraulic power section 150 to the mandrel (not shown) of bearing assembly 180 and, ultimately, drill bit 190. Flow diverter 170 is disposed between drive shaft assembly 160 and bearing assembly 180 and provides an inlet for drilling fluid and/or drilling mud (not shown) to lubricate and cool the bearings (not shown) and the mandrel (not shown) of bearing assembly 180 as well as the drill bit 190 during drilling operations.

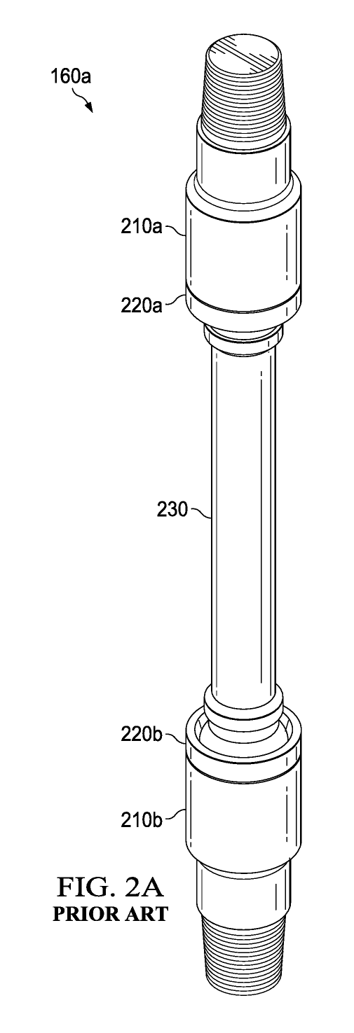

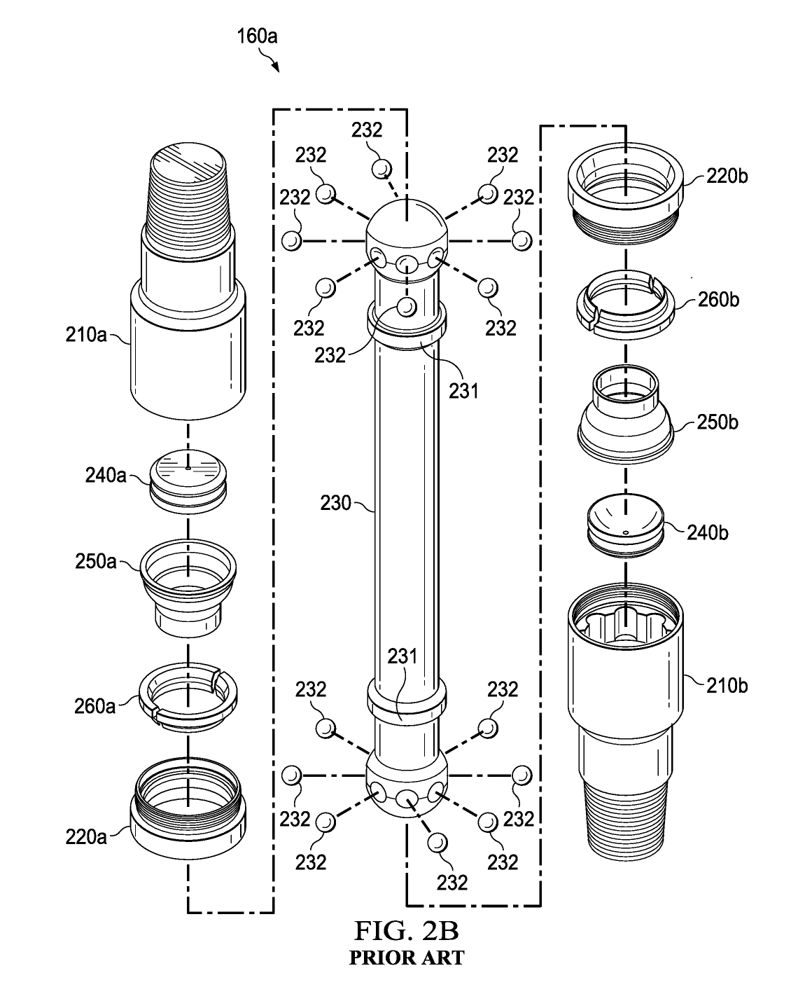

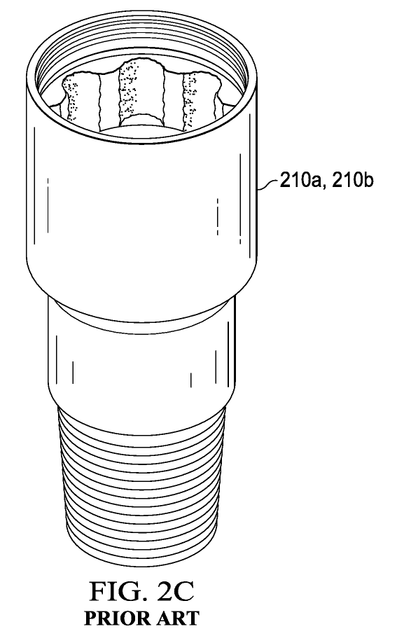

FIG. 2A shows a top-facing perspective view of a conventional drive shaft assembly 160a. Conventional drive shaft assembly 160a includes, in part, first adapter 210a, first adapter cap 220a, drive shaft 230, second adapter cap 220b, and second adapter 210b. First adapter 210a is mechanically connected to a hydraulic power section (e.g., 150 of FIG. 1) and receives eccentric rotation from the hydraulic power section (e.g., 150 of FIG. 1). The rotation of first adapter 210a rotates drive shaft 230. The rotation of drive shaft 230 rotates second adapter 210b. The rotation of second adapter 210b rotates a flow diverter (e.g., 170 of FIG. 1) that rotates a mandrel (not shown) of a bearing assembly (e.g., 180 of FIG. 1) that in turn rotates a drill bit (e.g., 190 of FIG. 1). Because of the freedom of movement between first adapter 210a and second adapter 210b, the eccentric rotation of first adapter 210a is converted into substantially concentric rotation at second adapter 210b.

Continuing in FIG. 2B, an exploded view of the conventional drive shaft assembly 160a is shown. As noted above, conventional drive shaft assembly 160a includes first adapter 210a, first adapter cap 220a, drive shaft 230, second adapter cap 220b, and second adapter 210b. Conventional drive shaft assembly 160a also includes first beryllium copper cap 240a, first boot 250a, first split ring clamp 260a, a first plurality of spheroidal balls 232, a second plurality of spheroidal balls 232, second split ring clamp 260b, second boot 250b, and second beryllium copper cap 240b.

First beryllium copper cap 240a is a consumable component typically made of beryllium copper. First beryllium copper cap 240a is a substantially cylindrical member that has diameter and a height that allows first beryllium copper cap 240a to be inserted into a corresponding cavity of first adapter 210a that is configured to receive it. A first side of first beryllium copper cap 240a includes a flat surface that is in limited moveable contact with a flat surface (not shown) of the corresponding cavity of first adapter 210a. A second side of first beryllium copper cap 240a includes a spheroidal cap indentation (not shown) configured to receive a portion of a first spheroidal end of drive shaft 230. In operation, first beryllium copper cap 240a tends to wear out over time giving rise to a variety of failure modes. As such, first beryllium copper cap 240a must be removed and replaced at regular intervals requiring the cessation of drilling operations, removal of the BHA (e.g., 195 from FIG. 1) from the wellbore, disassembly of the drive shaft assembly 160a, replacement of the first beryllium copper cap 240a, reassembly of the drive shaft assembly 160a, and redeployment of the BHA (e.g., 195 from FIG. 1).

First boot 250a is another consumable component that is typically made of synthetic rubber or fluoropolymer elastomer. First boot 250a includes a first end having a flared aperture of a first diameter and a second end having an aperture of a second diameter. A portion of drive shaft 230 extends through the second aperture of first boot 250a and the first end of first boot 250a covers a portion of a first universal joint formed by the first adapter cap 220a, the first spheroidal end of drive shaft 230, the first plurality of spheroidal balls 232, the first beryllium copper cap 240a, and the first adapter 210a protecting the first joint from drilling fluid and/or drilling mud and other particulate matter. In this way, first boot 250a functions as a temporary seal that protects the first joint from contamination and retains the lubrication necessary for the functionality of the first joint. In operation, first boot 250a tends to deform and ultimately disintegrate allowing the first joint to become contaminated, lose lubrication, and ultimately fail. As such, first boot 250a must be removed and/or replaced at regular intervals requiring the cessation of drilling operations, removal of the BHA (e.g., 195 from FIG. 1) from the wellbore, disassembly of the drive shaft assembly 160a, replacement of the first boot 250a, reassembly of the drive shaft assembly 160a, and redeployment of the BHA (e.g., 195 from FIG. 1).

First split ring clamp 260a is a retention member that is typically made out of a metal. First split ring clamp 260a includes a first end having a flared aperture of a first diameter and a second end having an aperture of a second diameter. The first end of first split ring clamp 260a wraps around the first end of first boot 250a within an inner diameter of first adapter cap 210a. The second end of first split ring clamp 260a is flush with an inner diameter of first adapter cap 220a and closes the clamp 260a when first adapter cap 220a is removably attached to first adapter 210a. First adapter cap 220a includes a first end (male threaded) configured to mate with a second end (female threaded) of first adapter 210a. The first end (male threaded) of first adapter 210a is connected to a hydraulic power section (e.g., 150 of FIG. 1).

Drive shaft 230 includes the first spheroidal end, a cylindrical shaft portion, and a second spheroidal end. Around the circumference of the first spheroidal end, a first plurality of ball cap indentations are disposed that are configured to receive a portion of the first plurality of spheroidal balls 232. Around the circumference of the second spheroidal end, a second plurality of ball cap indentations are formed that are configured to receive a portion of the second plurality of spheroidal balls 232.

Second beryllium copper cap 240b is a consumable component typically made of beryllium copper. Second beryllium copper cap 240b is a substantially cylindrical member that has diameter and a height that allows second beryllium copper cap 240b to be inserted into a corresponding cavity of second adapter 210b that is configured to receive it. A first side of second beryllium copper cap 240b includes a flat surface (not shown) that is in moveable contact with a flat surface of the corresponding cavity of second adapter 210b. A second side of second beryllium copper cap 240b includes a spheroidal cap indentation configured to receive a portion of a second spheroidal end of drive shaft 230. In operation, second beryllium copper cap 240b tends to wear out over time giving rise to a variety of failure modes. As such, second beryllium copper cap 240b must be removed and replaced at regular intervals requiring the cessation of drilling operations, removal of the BHA (e.g., 195 from FIG. 1) from the wellbore, disassembly of the drive shaft assembly 160a, replacement of the second beryllium copper cap 240b, reassembly of the drive shaft assembly 160a, and redeployment of the BHA (e.g., 195 from FIG. 1).

Second boot 250b is another consumable component that is typically made of synthetic rubber or fluoropolymer elastomer. Second boot 250b includes a first end having a flared aperture of a first diameter and a second end having an aperture of a second diameter. A portion of drive shaft 230 extends through the second aperture of second boot 250b and the first end of second boot 250b covers a portion of a second universal joint formed by the second adapter cap 220b, the second spheroidal end of drive shaft 230, the second plurality of spheroidal balls 232, the second beryllium copper cap 240b, and the second adapter 210b protecting the second joint from drilling fluid and/or drilling mud and other particulate matter. In this way, second boot 250b functions as a temporary seal that protects the second joint from contamination and retains the lubrication necessary for the functionality of the second joint. In operation, second boot 250b tends to deform and ultimately disintegrate allowing the second joint to become contaminated, lose lubrication, and ultimately fail. As such, second boot 250b must be removed and/or replaced at regular intervals requiring the cessation of drilling operations, removal of the BHA (e.g., 195 from FIG. 1) from the wellbore, disassembly of the drive shaft assembly 160a, replacement of the second boot 250b, reassembly of the drive shaft assembly 160a, and redeployment of the BHA (e.g., 195 from FIG. 1).

Second split ring clamp 260b is a retention member that is typically made out of metal. Second split ring clamp 260b includes a first end having a flared aperture of a first diameter and a second end having an aperture of a second diameter. The first end of second split ring clamp 260b wraps around the first end of second boot 250b within an interior diameter of second adapter 210b. The second end of second split ring clamp 260b is flush with second adapter cap 220b and closes the clamp 260b when second adapter cap 220b is removably attached to second adapter 210b. Second adapter cap 220b includes a first end (male threaded) configured to mate with a second end (female threaded) of second adapter 210b. The first end (male threaded) of second adapter 210b is connected to a bearing assembly (e.g., 180 of FIG. 1) by way of a flow diverter (e.g., 170 of FIG. 1).

Continuing in FIG. 2C, a worn-out adapter 210a, 210b of a conventional drive shaft assembly 160a is shown. During drilling operations, there are various actions taken by the driller that impart jarring axial loads on conventional drive shaft assembly 160a. These jarring axial loads may be true axial loads, semi-axial loads offset by an angle that may vary, or axial or semi-axial loads related to the precession of the axis of rotation caused by eccentric rotation or other movements. These loads may be thought of as pulling or pushing or the BHA (e.g., 195 of FIG. 1) in a jarring manner. The result of these jarring axial loads is the premature wear out of first and/or second adapters 210a, 210b where the recessed portions configured to receive the plurality of spheroidal balls 232 become deformed or otherwise damaged or drive shaft 230 bends or breaks. As noted above, the objective of the conventional drive shaft assembly 160a is to transmit torque to the drill bit (e.g., 190 of FIG. 1) by converting eccentric rotation provided by the hydraulic power section (e.g., 150 of FIG. 1) to concentric rotation at the drill bit (e.g., 190 of FIG. 1). As such, first adapter 210a must be able to rotate drive shaft 230, which in turn must be able to rotate second adapter 210b. The spheroidal balls 232, and their close fit with their respective adapters 210a and 210b, are critical to this functionality. If either adapter 210a or 210b becomes deformed or otherwise damaged due these jarring axial loads, or vibration, then conventional drive shaft assembly 160b will fail, potentially resulting in deformation or damage to itself or other constituent parts of the BHA (e.g., 195 of FIG. 1). The failure modes may include slippage as the spheroidal balls 232 no longer catch in damaged recessed portions of their respective adapters 210a or 210b, and breakage of various components. This results in non-productive downtime that causes drilling operations to stop, the BHA (e.g., 195 of FIG. 1) typically must be fished out of the hole, the damaged components must be repaired or replaced, and the BHA (e.g., 195 of FIG. 1) must be tripped back into the hole before drilling operations can resume. As such, there is a long felt, but unsolved, need in the industry for a drive shaft assembly capable of withstanding such jarring axial loads and vibration that is easily serviced in the field.

Accordingly, in one or more embodiments of the present invention, a reciprocation-dampening drive shaft assembly can withstand jarring axial loads, including precession, as well as vibration, without slippage or damage to the adapters of the drive shaft assembly, thereby extending productive uptime of drilling operations. As such, a reciprocation-dampening drive shaft assembly may be used in place of a conventional drive shaft assembly and provide improved operational service life. Advantageously, a reciprocation-dampening drive shaft assembly reduces non-productive downtime and reduces operational costs for drilling operations. Even when consumable parts require replacement, the simplicity and elegance of the design allows the reciprocation-dampening drive shaft assembly to be easily serviced in the field.

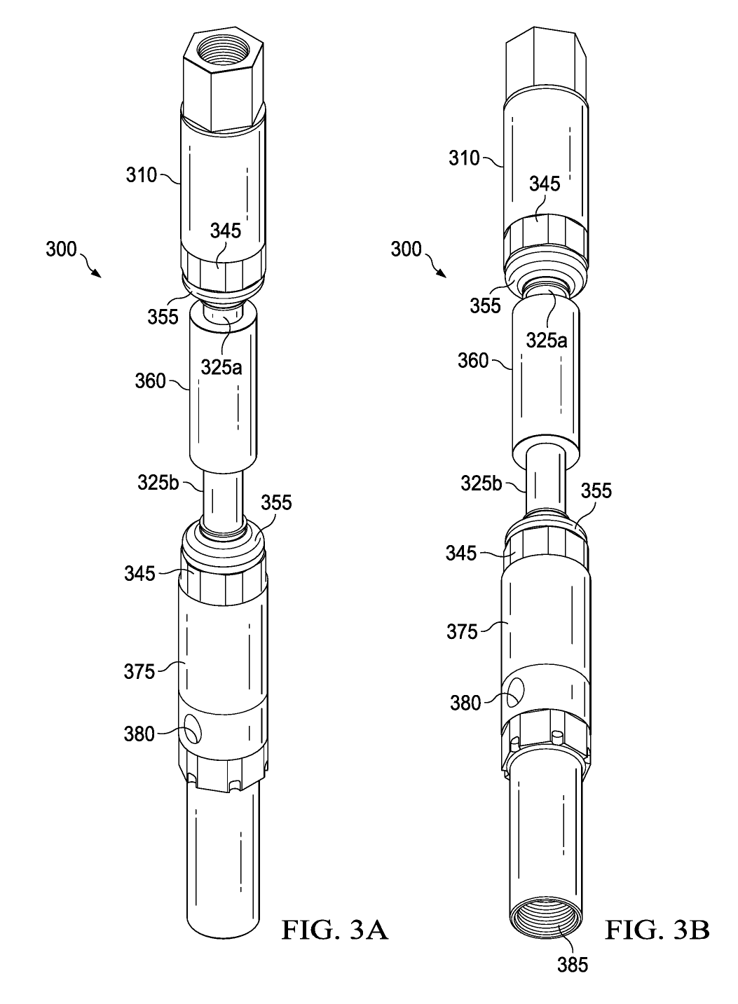

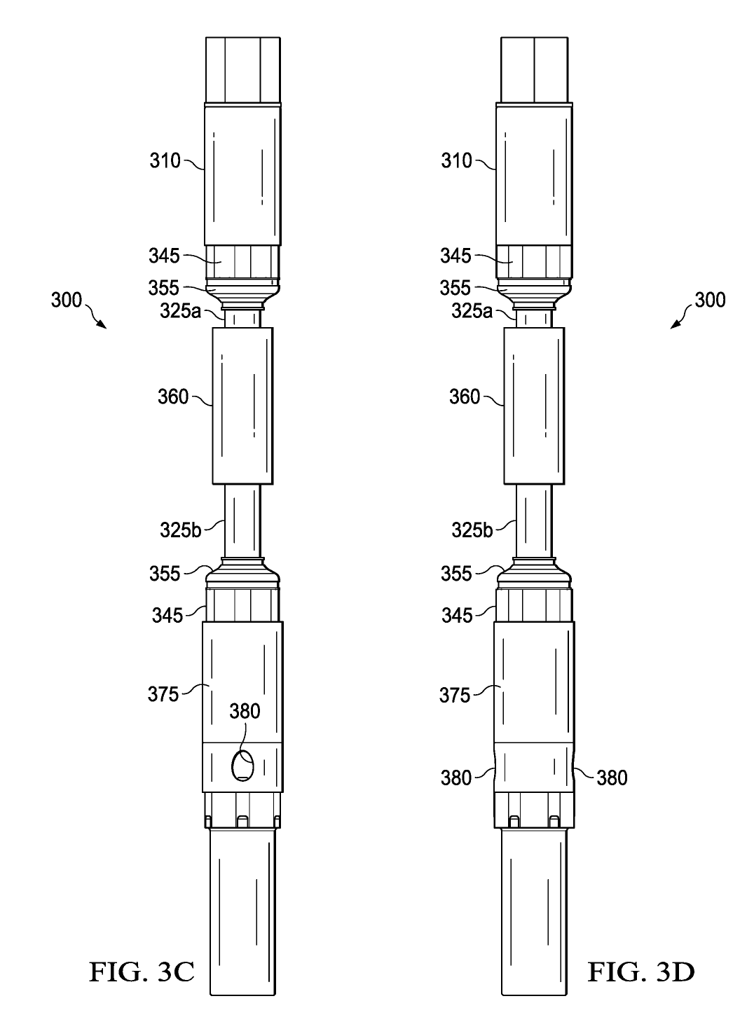

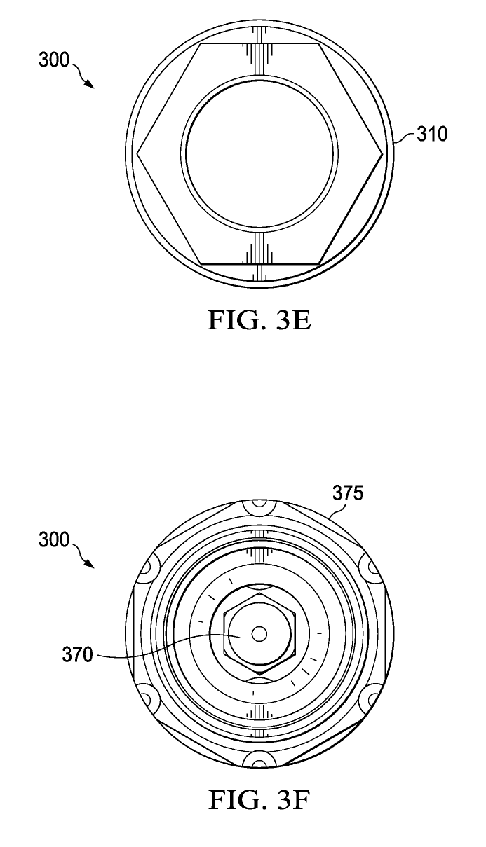

FIG. 3A shows a top-facing perspective view of a reciprocation-dampening drive shaft assembly 300 in accordance with one or more embodiments of the present invention. Reciprocation-dampening drive shaft assembly 300 may include, in part, a first reciprocation-dampening adapter 310, a first reciprocation-dampening adapter cap 345, a first boot 355, a first drive shaft portion 325a, a drive shaft joint 360, a second drive shaft portion 325b, a second boot 355, a second reciprocation-dampening adapter cap 345, a bottom ring 365, and a second reciprocation-dampening adapter 375. First reciprocation-dampening adapter 310 may mechanically connect to a hydraulic power section (e.g., 150 of FIG. 1) that provides eccentric rotation. The rotation of first reciprocation-dampening adapter 310 may rotate first drive shaft portion 325a and second drive shaft portion 325b. The rotation of second drive shaft portion 325b may rotate second reciprocation-dampening adapter 375. In certain embodiments, including the one depicted in the figure, second reciprocation-dampening adapter 375 may include an integrated flow diverter (e.g., 170 of FIG. 1) that rotates a mandrel (not shown) of the bearing assembly (e.g., 180 of FIG. 1) that in turn rotates a drill bit (e.g., 190 of FIG. 1). In other embodiments, second reciprocation-dampening adapter 375 may not include an integrated flow diverter (not shown). Because of the freedom of movement between first reciprocation-dampening adapter 310 and second reciprocation-dampening adapter 375, the eccentric rotation of first reciprocation-dampening adapter 310 is converted into substantially concentric rotation at second reciprocation-dampening adapter 375. Continuing, FIG. 3B shows a bottom-facing perspective view of the reciprocation-dampening drive shaft assembly 300 in accordance with one or more embodiments of the present invention. As discussed in more detail herein, fluids are directed into one or more flow diverter ports 380 that are fluidly connected to an interior passageway 385 that terminates on a distal end of second reciprocation-dampening adapter 375, thereby providing fluids to the bearing assembly (e.g., 180 of FIG. 1) and drill bit (e.g., 190 of FIG. 1). Continuing, FIG. 3C shows a front elevation view, FIG. 3D shows a side elevation view, FIG. 3E shows a top plan view, and FIG. 3F shows a bottom plan view of the reciprocation-dampening drive shaft assembly 300 in accordance with one or more embodiments of the present invention.

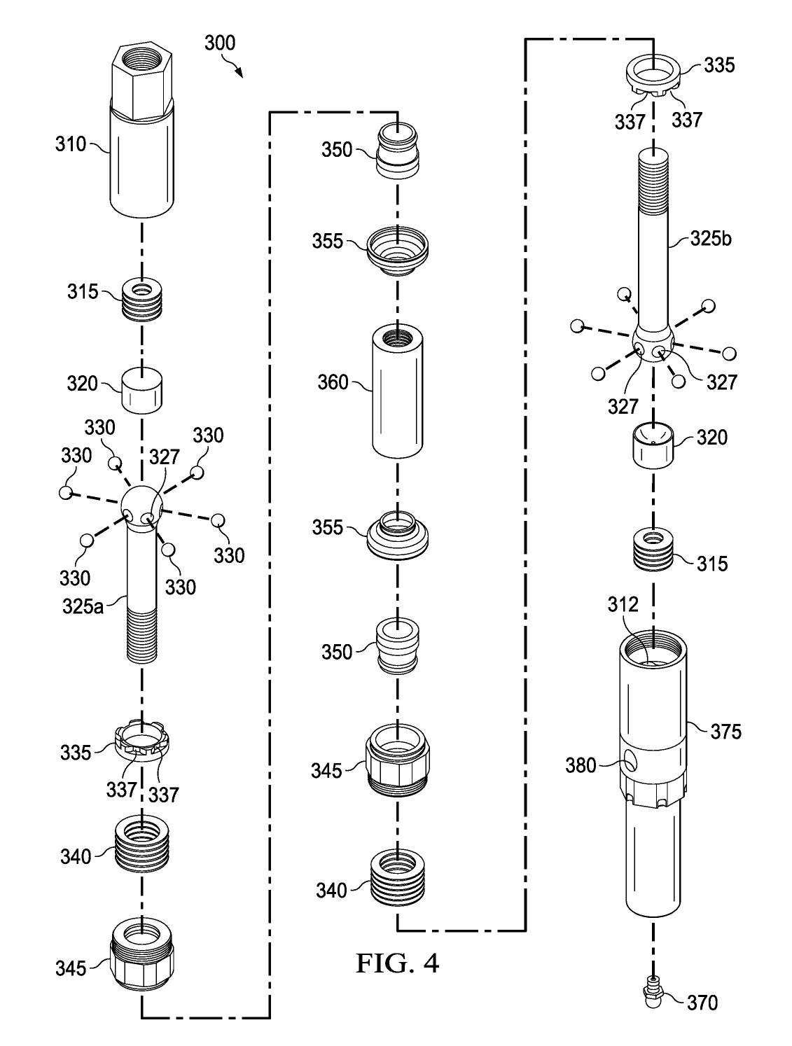

FIG. 4 shows an exploded view of a reciprocation-dampening drive shaft assembly 300 in accordance with one or more embodiments of the present invention.

A first reciprocation-dampening adapter 310 may include a connection end and a cylindrical adapter portion. The cylindrical adapter portion may include a recessed inner aperture having a first diameter (not shown), a recessed inner aperture having a second diameter (not shown) and a plurality of semispheroidal recessed portions, and an adapter threaded end (not shown).

A first plurality of spring washers 315 may be disposed within the recessed inner aperture having the first diameter (not shown) of the first reciprocation-dampening adapter 310. The first plurality of spring washers 315 may have a first inner diameter.

A first floating seat 320 may be disposed within the recessed inner aperture having the first diameter (not shown) of the first reciprocation-dampening adapter 310 on a spring loaded side of the first plurality of spring washers 315. The first floating seat 320 may be a substantially cylindrical member that has a flat surface on a first side that is in moveable contact with the first plurality of spring washers 315 disposed within the recessed inner aperture having the first diameter (not shown) of the first reciprocation-dampening adapter 310. A second side of first floating seat 320 may include a spheroidal cap indentation configured to movably receive a portion of a spheroidal end of a first drive shaft portion 325a. The first floating seat 320 may include a central lumen that fluidly connects the spheroidal end of the first drive shaft portion 325a and the recessed inner aperture having the first diameter (not shown) of the first reciprocation-dampening adapter 310, where grease or lubricant may be disposed.

A first drive shaft portion 325a may include the spheroidal end, a cylindrical shaft portion, and shaft threaded end. The spheroidal end may include a plurality of ball cap indentations 327 disposed about its outer surface. One of ordinary skill in the art will recognize that the number, size, and location of ball cap indentations 327 may vary based on an application or design in accordance with one or more embodiments of the present invention. A first plurality of spheroidal balls 330 may be partially disposed within the plurality of ball cap indentations 327 of first drive shaft portion 325a.

A first floating ring 335 may include a plurality of semispheroidal recessed portions 337 on a first side and substantially flat surface on a second side (not shown). The plurality of semispheroidal recessed portions (not shown) of first reciprocation-dampening adapter 310 may be configured to receive a portion of the first plurality of balls 330 partially disposed within the plurality of ball cap indentations 327 of first drive shaft portion 325a when first drive shaft portion 325a is inserted into first reciprocation-dampening adapter 310. The plurality of semispheroidal recessed portions 337 of first floating ring 335 may be configured to receive another portion of the first plurality of balls 330 partially disposed within the plurality of ball cap indentations 327 of the spheroidal end of the first drive shaft portion 325a. First floating ring 335 may be disposed in the recessed inner aperture having a second diameter (not shown) of the first reciprocation-dampening adapter 310. First drive shaft portion 325a may be disposed through a central lumen of first floating ring 335.

A first plurality of spring washers 340, having a second inner diameter, larger than the first inner diameter of washers 315, may be disposed within the recessed inner aperture having the second diameter (not shown) of the first reciprocation-dampening adapter 310. The second inner diameter may be large enough to pass the cylindrical shaft portion of the first drive shaft portion 325a. The first plurality of spring washers 340 may be disposed such that their spring loaded side is facing a first reciprocation-dampening adapter cap 345.

The first reciprocation-dampening adapter cap 345 may include a recessed dampener aperture configured to receive a first dampener insert 350 and a first adapter cap threaded end configured to removably connect to the first adapter threaded end of the first reciprocation-dampening adapter 310. The recessed dampener aperture (not shown) of the first reciprocation-dampening adapter cap 345 may be tapered in a direction toward the adapter cap threaded end and includes a plurality of ridges (not shown) configured to secure the first dampener insert 350 within the first reciprocation-dampening adapter cap 345. When the first reciprocation-dampening adapter cap 345 is connected to the first reciprocation-dampening adapter 310, the spheroidal end of first drive shaft portion 325a may be securely disposed within first reciprocation-dampening adapter 310.

A first boot 355 may be configured to seal the first reciprocation-dampening adapter cap 345 and the cylindrical shaft portion of the first drive shaft portion 325a. The first reciprocation-dampening adapter cap 345 may include a recessed area disposed about its outer surface configured to secure a first end of the first boot 355 to the first reciprocation-dampening adapter cap 345.

A drive shaft joint 360 may include a first distal end configured to receive the shaft threaded end of the first drive shaft portion 325a and a second distal end configured to receive the shaft threaded end of the second drive shaft portion 325b.

A second reciprocation-dampening adapter 375 may include a connection end, a cylindrical adapter portion, and a flow diverter portion. The cylindrical adapter portion includes a recessed inner aperture having the first diameter (partially shown), a recessed inner aperture having a second diameter (not shown) and a plurality of semispheroidal recessed portions 312, and a second adapter threaded end (not shown). The flow diverter portion of the second reciprocation-dampening adapter 375 may include a one or more flow diverter ports 380 fluidly connected to an interior passageway (not shown) that fluidly communicates with a distal end of second reciprocation-dampening adapter 375. A grease injection nipple 370 may be disposed within a recessed inner aperture (not shown) of the interior passageway of the distal end of second reciprocation-dampening adapter 375. Grease injection nipple 370 may be used to inject grease or lubricant into the sealed joint of the second reciprocation-dampening adapter 375 when assembled.

A second plurality of spring washers 315 may be disposed within the recessed inner aperture having the first diameter (partially shown) of the second reciprocation-dampening adapter 375. The second plurality of spring washers 315 may have the first inner diameter.

A second floating seat 320 may be disposed within the recessed inner aperture having the first diameter (not shown) of the second reciprocation-dampening adapter 375 on a spring loaded side of the second plurality of spring washers 315. The second floating seat 320 may be a substantially cylindrical member that has a flat surface on a first side that is in moveable contact with the second plurality of spring washers 315 disposed within the recessed inner aperture having the first diameter (not shown) of the second reciprocation-dampening adapter 375. A second side of second floating seat 320 may include a spheroidal cap indentation configured to movably receive a portion of a spheroidal end of the second drive shaft portion 325b. The second floating seat 320 may include a central lumen that fluidly connects the spheroidal end of the second drive shaft portion 325b and the interior passageway of the flow diverter portion of the second reciprocation-dampening adapter 310.

A second drive shaft portion 325b may include the spheroidal end, a cylindrical shaft portion, and shaft threaded end. The spheroidal end may include a plurality of ball cap indentations 327 disposed about its outer surface. One of ordinary skill in the art will recognize that the number of ball cap indentations 327 may vary based on an application or design in accordance with one or more embodiments of the present invention. A second plurality of spheroidal balls 330 may be partially disposed within the plurality of ball cap indentations 327 of second drive shaft portion 325b. In certain embodiments, including the one depicted in the figure, the cylindrical shaft portion of second drive shaft portion 325b may be longer than the cylindrical shaft portion of the first drive shaft portion 325a. One of ordinary skill in the art will recognize that the lengths of the cylindrical drive shaft portions of the first 325a and second 325b drive shaft portions may vary based on an application or design in accordance with one or more embodiments of the present invention.

A second floating ring 335 may include a plurality of semispheroidal recessed portions 337 on a first side (partially shown) and substantially flat surface on a second side. The plurality of semispheroidal recessed portions (partially shown) of second reciprocation-dampening adapter 375 may be configured to receive a portion of the second plurality of balls 330 partially disposed within the plurality of ball cap indentations 327 of second drive shaft portion 325b when second drive shaft portion 325b is inserted into second reciprocation-dampening adapter 375. The plurality of semispheroidal recessed portions 337 of second floating ring 335 may be configured to receive another portion of the second plurality of balls 330 partially disposed within the plurality of ball cap indentations 327 of the spheroidal end of the second drive shaft portion 325b. Second floating ring 335 may be disposed in the recessed inner aperture having a second diameter (not shown) of the second reciprocation-dampening adapter 375. Second drive shaft portion 325b may be disposed through a central lumen of second floating ring 335.

A second plurality of spring washers 340, having the second inner diameter, larger than the first inner diameter of washers 315, may be disposed within the recessed inner aperture having the second diameter (not shown) of the second reciprocation-dampening adapter 375. The second inner diameter may be large enough to pass the cylindrical shaft portion of the second drive shaft portion 325b. The second plurality of spring washers 340 may be disposed such that their spring loaded side is facing a second reciprocation-dampening adapter cap 345.

The second reciprocation-dampening adapter cap 345 may include a recessed dampener aperture configured to receive a second dampener insert 350 and a second adapter cap threaded end configured to removably connect to the second adapter threaded end of second reciprocation-dampening adapter 375. The recessed dampener aperture (not shown) of second reciprocation-dampening adapter cap 345 may be tapered in a direction toward the second adapter cap threaded end of second reciprocation-dampening adapter cap 345 and include a plurality of ridges (not shown) configured to secure the second dampener insert 350 within the second reciprocation-dampening adapter cap 345. When the second reciprocation-dampening adapter cap 345 is connected to second reciprocation-dampening adapter 375, the spheroidal end of second drive shaft portion 325b may be securely disposed within second reciprocation-dampening adapter 375.

A second boot 355 may be configured to seal the second reciprocation-dampening adapter cap 345 and the cylindrical shaft portion of the second drive shaft portion 325b. The second reciprocation-dampening adapter cap 345 may include a recessed area disposed about its outer surface configured to secure a first end of the second boot 355 to the second reciprocation-dampening adapter cap 345.

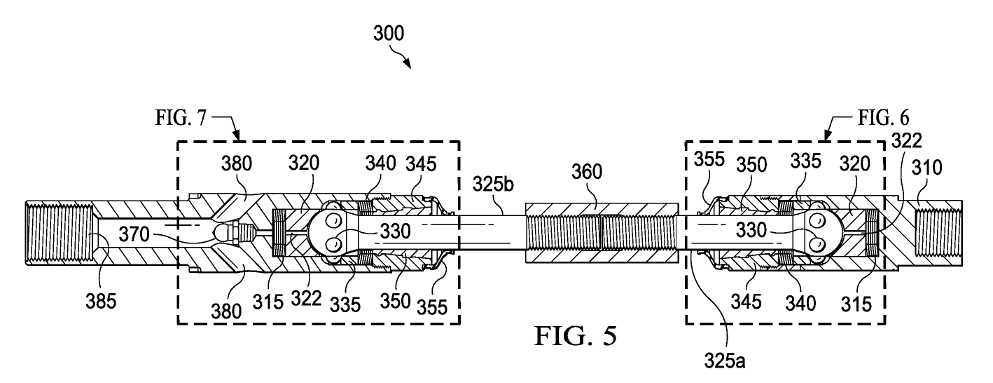

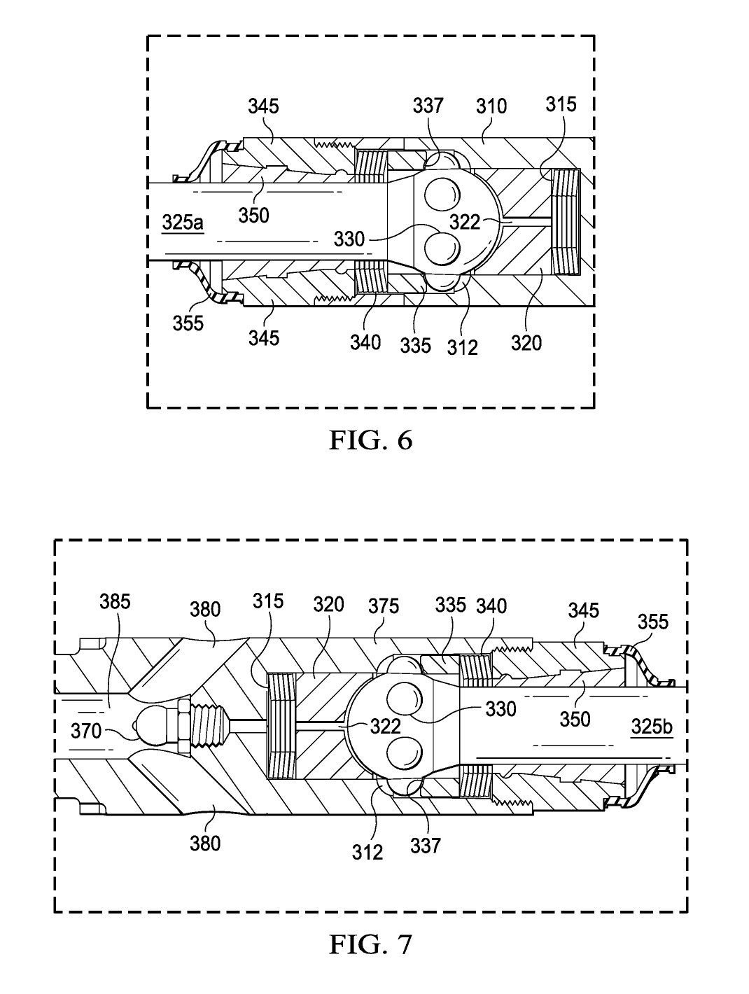

FIG. 5 shows a cross-sectional view of a reciprocation-dampening drive shaft assembly 300 in accordance with one or more embodiments of the present invention. A detailed cross-sectional view of an assembled portion of a first reciprocation-dampening adapter 310 of the reciprocation-dampening drive shaft assembly 300 is shown in FIG. 6 and a detailed cross-sectional view of an assembled portion of a second reciprocation-dampening adapter 375 of the reciprocation-dampening drive shaft assembly 300 is shown in FIG. 7. However, in this cross-sectional view, the shaft threaded end of first drive shaft portion 325a and the shaft threaded end of second drive shaft portion 325b are shown connected to opposing distal ends of drive shaft joint 360. Splitting the drive shaft into first 325a and second 325b portions facilitates assembly as well as decouples mechanical stresses and increases the strength of the most vulnerable portion of the drive shaft, thereby preventing or reducing breakage.

FIG. 6 shows a detailed cross-sectional view of an assembled portion of a first reciprocation-dampening adapter 310 of a reciprocation-dampening drive shaft assembly 300 in accordance with one or more embodiments of the present invention. In this assembled cross-sectional view, a configuration of the components and their intended functionality is more clearly shown. Within the recessed inner aperture having the first diameter of the first reciprocation-dampening adapter 310, the first plurality of spring washers 315 are shown with the spring loaded end facing the spheroidal end of the first drive shaft portion 325a. Also within this same recessed inner aperture, the first floating seat 320 is shown. The flat surface on the first side of the first floating seat 320 is shown in movable contact with the spring loaded end of the first plurality of spring washers 315. The second side of the first floating seat 320 may include a spheroidal cap indentation configured to receive a portion of a spheroidal end of the first drive shaft portion 325a. A central lumen 322 may fluidly connect the spheroidal end of the first drive shaft portion 325a and the recessed inner aperture having the first diameter of the first reciprocation-dampening adapter 310.

The first plurality of balls 330 partially disposed within the plurality of ball cap indentations 327 of the spheroidal end of the first drive shaft portion 325a are shown where a portion of the balls 330 are fitted into the plurality of semispheroidal recessed portions 312 of first reciprocation-dampening adapter 310. Similarly, the plurality of semispheroidal recessed portions 337 of the first floating ring 335 are shown movably fitted to further support balls 330. A first plurality of spring washers 340 are shown disposed within the recessed inner aperture having the second diameter of the first reciprocation-dampening adapter 310. The spring loaded end of the first plurality of spring washers 340 are facing the in the direction of the first reciprocation-dampening adapter cap 345. The adapter cap threaded end of the first reciprocation-dampening adapter cap 345 may removably connect to the adapter threaded end of the first reciprocation-dampening adapter 310, with the cylindrical shaft portion of the first drive shaft portion 325a extending therethrough. The recessed dampener aperture of the first reciprocation-dampening adapter cap 345 is shown with a first dampener insert 350 installed. The first boot 355 seals the first reciprocation-dampening adapter cap 345 to the cylindrical shaft portion of the first drive shaft portion 325a.

When axial loads are exerted, the first plurality of spring washers 315, the first floating seat 320, the first floating ring 335, the first plurality of spring washers 340, and the first dampener insert 350, provide improved freedom of movement, including the ability to withstand axial loads, while maintaining a protective and secure grip on the spheroidal end of the first drive shaft portion 325a that prevents such loads, or vibrations, from damaging the semispheroidal recessed portions 312 of the first reciprocation-dampening adapter 310 or other components of the drive shaft assembly 300.

FIG. 7 shows a detailed cross-sectional view of an assembled portion of a second reciprocation-dampening adapter 375 of a reciprocation-dampening drive shaft assembly 300 in accordance with one or more embodiments of the present invention. In this assembled cross-sectional view, a configuration of the components and their intended functionality is more clearly shown. Within the recessed inner aperture having the first diameter of the second reciprocation-dampening adapter 375, the second plurality of spring washers 315 are shown with the spring loaded end facing the spheroidal end of the second drive shaft portion 325b. Also within this same recessed inner aperture, the second floating seat 320 is shown. The flat surface on the first side of the second floating seat 320 is shown in movable contact with the spring loaded end of the second plurality of spring washers 315. The second side of the second floating seat 320 may include a spheroidal cap indentation configured to receive a portion of a spheroidal end of the second drive shaft portion 325b. A central lumen 322 may fluidly connect the spheroidal end of the second drive shaft portion 325b and grease injection nipple 370 that may be used to inject grease or lubricant.

The second plurality of balls 330 partially disposed within the plurality of ball cap indentations 327 of the spheroidal end of the second drive shaft portion 325b are shown where a portion of the balls 330 are fitted into the plurality of semispheroidal recessed portions 312 of second reciprocation-dampening adapter 375. Similarly, the plurality of semispheroidal recessed portions 337 of the second floating ring 335 are shown movably fitted to further support balls 330. A second plurality of spring washers 340 are shown disposed within the recessed inner aperture having the second diameter of the second reciprocation-dampening adapter 375. The spring loaded end of the second plurality of spring washers 340 are facing the in the direction of the second reciprocation-dampening adapter cap 345. The second adapter cap threaded end of the second reciprocation-dampening adapter cap 345 may removably connect to the second adapter threaded end of second reciprocation-dampening adapter 375, with the cylindrical shaft portion of the second drive shaft portion 325b extending therethrough. The recessed dampener aperture of the second reciprocation-dampening adapter cap 345 is shown with a second dampener insert 350 installed. The second boot 355 seals the second reciprocation-dampening adapter cap 345 to the cylindrical shaft portion of the second drive shaft portion 325b.

When axial loads are exerted, the second plurality of spring washers 315, the second floating seat 320, the second floating ring 335, the second plurality of spring washers 340, and the second dampener insert 350, provide improved freedom of movement, including the ability to withstand axial loads, while maintaining a protective and secure grip on the spheroidal end of the second drive shaft portion 325b that prevents such loads, or vibrations, from damaging the semispheroidal recessed portions 312 of the second reciprocation-dampening adapter 375 or other components of the drive shaft assembly 300.

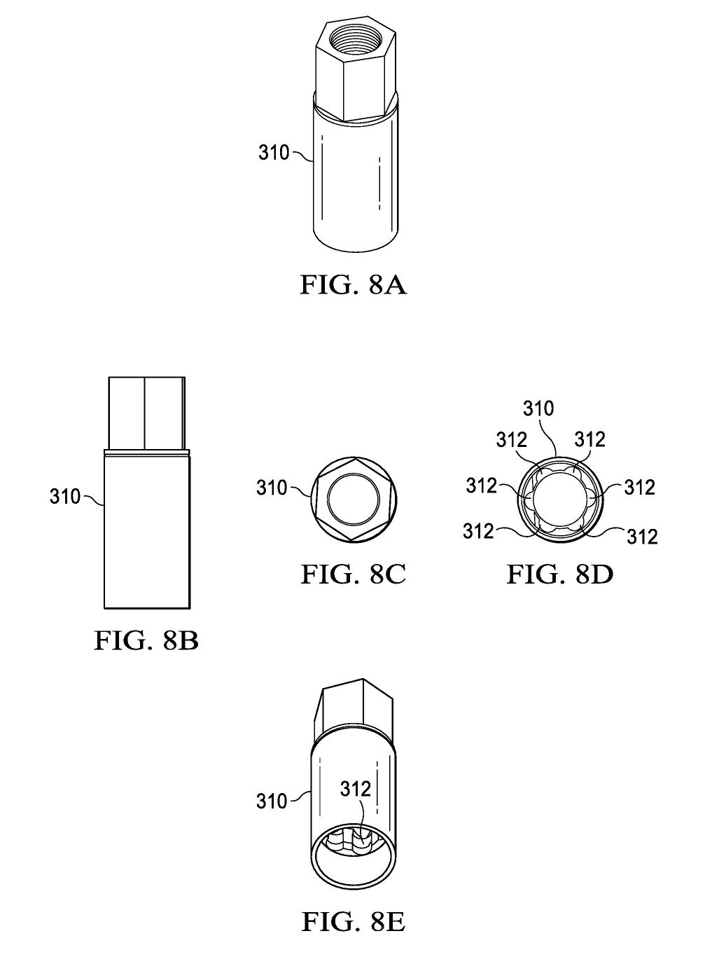

FIG. 8A shows a top-facing perspective view of a first reciprocation-dampening adapter 310 of a reciprocation-dampening drive shaft assembly 300 in accordance with one or more embodiments of the present invention. Continuing, FIG. 8B shows a side elevation view of the first reciprocation-dampening adapter 310 of the reciprocation-dampening drive shaft assembly 300 in accordance with one or more embodiments of the present invention. Continuing, FIG. 8C shows a top plan view of the first reciprocation-dampening adapter 310 of the reciprocation-dampening drive shaft assembly 300 in accordance with one or more embodiments of the present invention. Continuing, FIG. 8D shows a bottom plan view of the first reciprocation-dampening adapter 310 of the reciprocation-dampening drive shaft assembly 300 in accordance with one or more embodiments of the present invention. Continuing, FIG. 8E shows a bottom-facing perspective view of the first reciprocation-dampening adapter 310 of the reciprocation-dampening drive shaft assembly 300 in accordance with one or more embodiments of the present invention. One of ordinary skill in the art will recognize that the connection end and the cylindrical adapter portion may vary based on an application or design in accordance with one or more embodiments of the present invention.

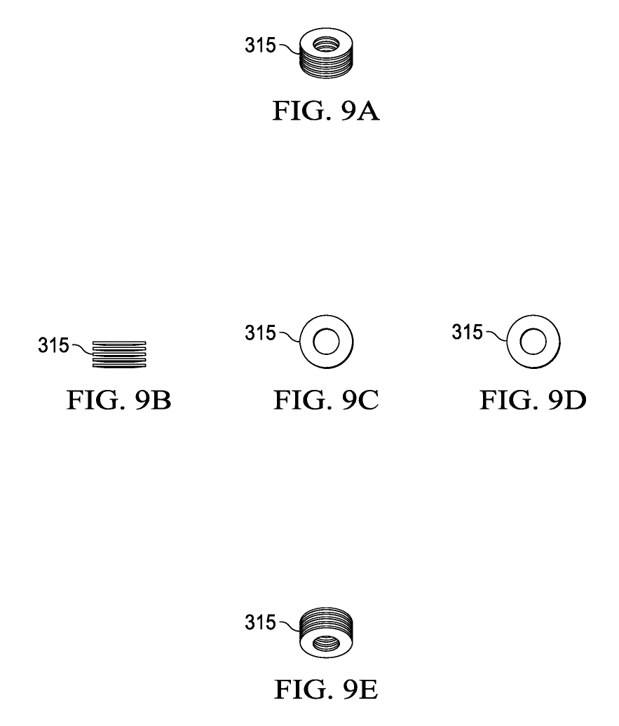

FIG. 9A shows a top-facing perspective view of a plurality of spring washers 315 of a reciprocation-dampening drive shaft assembly 300 in accordance with one or more embodiments of the present invention. Spring washers 315 are intended to be disposed within the recessed inner aperture having the first diameter of either the first reciprocation-dampening adapter 310 or second reciprocation-dampening adapter 375 to provide for limited axial movement. Continuing, FIG. 9B shows a side elevation view of the plurality of spring washers 315 of the reciprocation-dampening drive shaft assembly 300 in accordance with one or more embodiments of the present invention. Continuing, FIG. 9C shows a top plan view of the plurality of spring washers 315 of the reciprocation-dampening drive shaft assembly 300 in accordance with one or more embodiments of the present invention. Continuing, FIG. 9D shows a bottom plan view of the plurality of spring washers 315 of the reciprocation-dampening drive shaft assembly 300 in accordance with one or more embodiments of the present invention. Continuing, FIG. 9E shows a bottom-facing perspective view of the plurality of spring washers 315 of the reciprocation-dampening drive shaft assembly 300 in accordance with one or more embodiments of the present invention.

One of ordinary skill in the art will recognize that the number of spring washers 315 used may vary to adjust the spring constant based on an application or design in accordance with one or more embodiments of the present invention. In certain embodiments, the plurality of spring washers 315 may be Belleville washers. In other embodiments, one or more gas springs (not shown) may be used in place of the plurality of spring washers 315. In still other embodiments, one or more extension springs (not shown) may be used in place of the plurality of spring washers 315. One of ordinary skill in the art will recognize that the type or kind of spring washers 315 used may vary based on an application or design in accordance with one or more embodiments of the present invention.

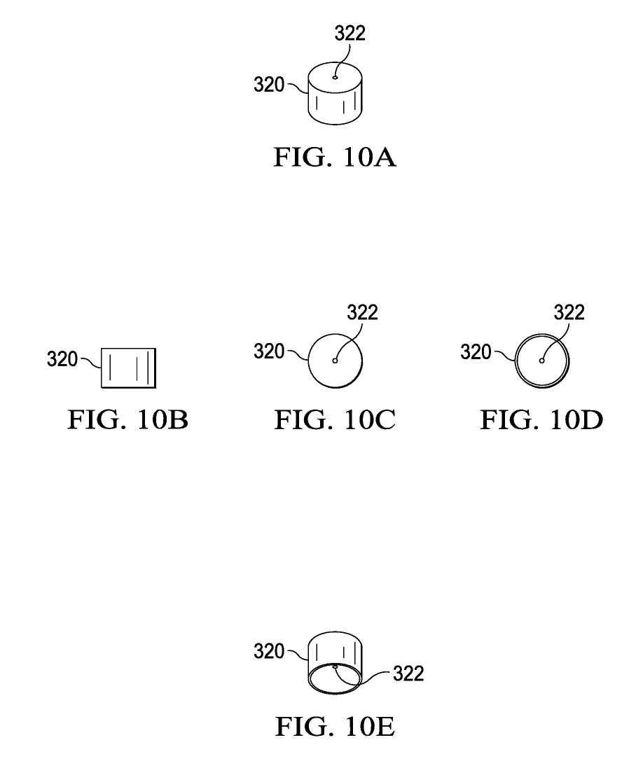

FIG. 10A shows a top-facing perspective view of a floating seat 320 of a reciprocation-dampening drive shaft assembly 300 in accordance with one or more embodiments of the present invention. Continuing, FIG. 10B shows a side elevation view of floating seat 320 of the reciprocation-dampening drive shaft assembly 300 in accordance with one or more embodiments of the present invention. Continuing, FIG. 10C shows a top plan view of floating seat 320 of the reciprocation-dampening drive shaft assembly 300 in accordance with one or more embodiments of the present invention. Continuing, FIG. 10D shows a bottom plan view of floating seat 320 of the reciprocation-dampening drive shaft assembly 300 in accordance with one or more embodiments of the present invention. Continuing, FIG. 10E shows a bottom-facing perspective view of floating seat 320 of the reciprocation-dampening drive shaft assembly 300 in accordance with one or more embodiments of the present invention. One of ordinary skill in the art will recognize that the shape, size, and configuration of floating seat 320 may vary based on an application or design in accordance with one or more embodiments of the present invention.

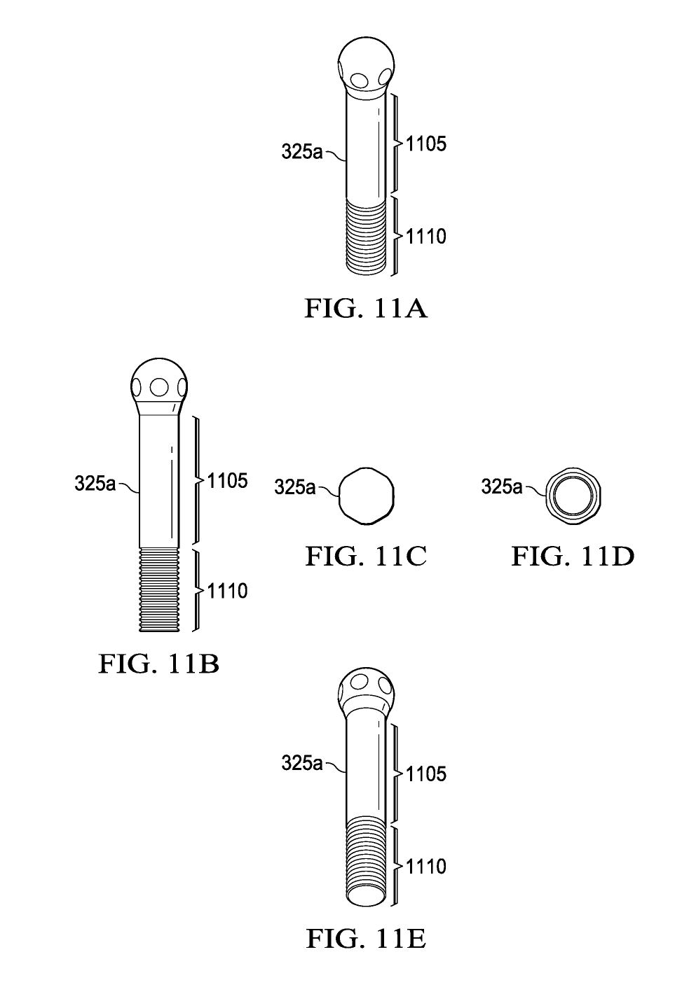

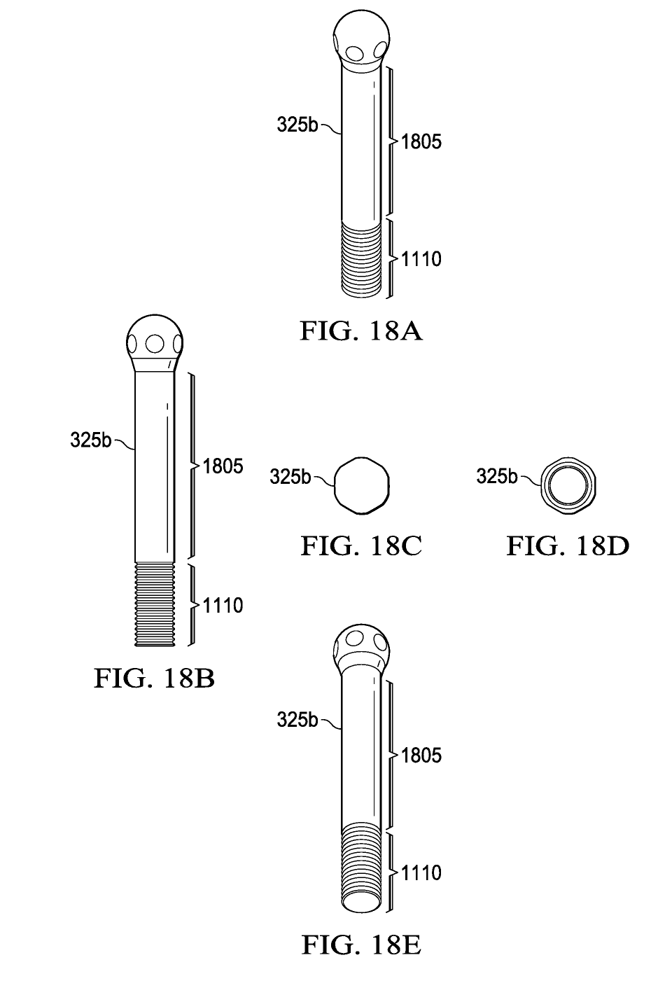

FIG. 11A shows a top-facing perspective view of a first drive shaft portion 325a of a reciprocation-dampening drive shaft assembly 300 in accordance with one or more embodiments of the present invention. First drive shaft portion 325a may include a spheroidal end, a cylindrical shaft portion 1105, and a shaft threaded end 1110. In certain embodiments, including those depicted in the figures, first drive shaft portion 325a may have a cylindrical shaft portion 1105 that is shorter than the cylindrical shaft portion (e.g., 1805 of FIG. 18) of the second drive shaft portion 325b. Cylindrical shaft portion 1105 of the first drive shaft portion 325a may be shorter than, longer than, or substantially equal in length to the cylindrical shaft portion (e.g., 1805 of FIG. 18) of the second drive shaft portion (e.g., 325b of FIG. 18). One of ordinary skill in the art will recognize that the length and diameter of the cylindrical shaft portion 1805 may vary based on an application or design in accordance with one or more embodiments of the present invention. Continuing, FIG. 11B shows a side elevation view of the first drive shaft portion 325a of the reciprocation-dampening drive shaft assembly 300 in accordance with one or more embodiments of the present invention. Continuing, FIG. 11C shows a top plan view of the first drive shaft portion 325a of the reciprocation-dampening drive shaft assembly 300 in accordance with one or more embodiments of the present invention. Continuing, FIG. 11D shows a bottom plan view of the first drive shaft portion 325a of the reciprocation-dampening drive shaft assembly 300 in accordance with one or more embodiments of the present invention. Continuing, FIG. 11E shows a bottom-facing perspective view of the first drive shaft portion 325a of the reciprocation-dampening drive shaft assembly 300 in accordance with one or more embodiments of the present invention. One of ordinary skill in the art will recognize that the shape, size, and configuration of first drive shaft portion 325a may vary based on an application or design in accordance with one or more embodiments of the present invention.

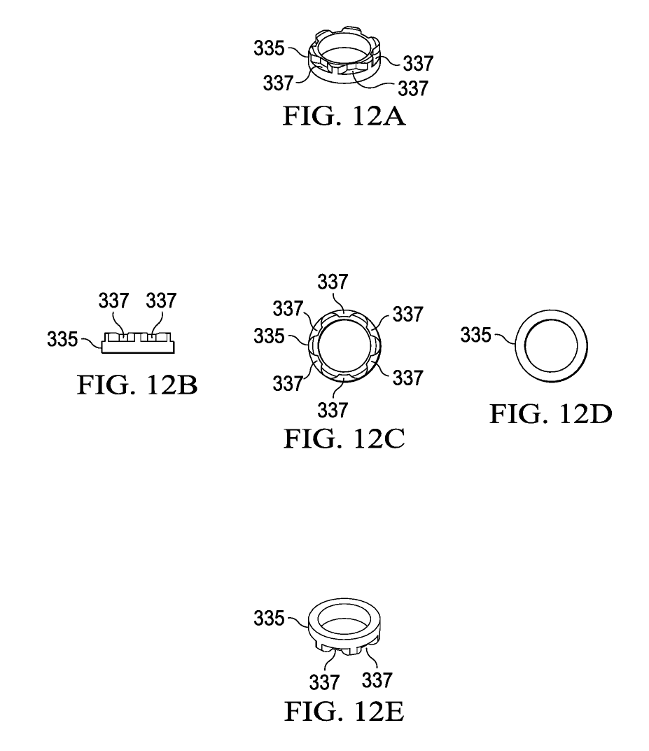

FIG. 12A shows a top-facing perspective view of a floating ring 335 of a reciprocation-dampening drive shaft assembly 300 in accordance with one or more embodiments of the present invention. Continuing, FIG. 12B shows a side elevation view of the floating ring 335 of the reciprocation-dampening drive shaft assembly 300 in accordance with one or more embodiments of the present invention. Continuing, FIG. 12C shows a top plan view of the floating ring 335 of the reciprocation-dampening drive shaft assembly 300 in accordance with one or more embodiments of the present invention. Continuing, FIG. 12D shows a bottom plan view of the floating ring 335 of the reciprocation-dampening drive shaft assembly 300 in accordance with one or more embodiments of the present invention. Continuing, FIG. 12E shows a bottom-facing perspective view of the floating ring 335 of the reciprocation-dampening drive shaft assembly 300 in accordance with one or more embodiments of the present invention. One of ordinary skill in the art will recognize that the shape, size, and configuration of floating ring 335, including the shape, size, configuration and number of semispheroidal recessed portions 337, may vary based on an application or design in accordance with one or more embodiments of the present invention.

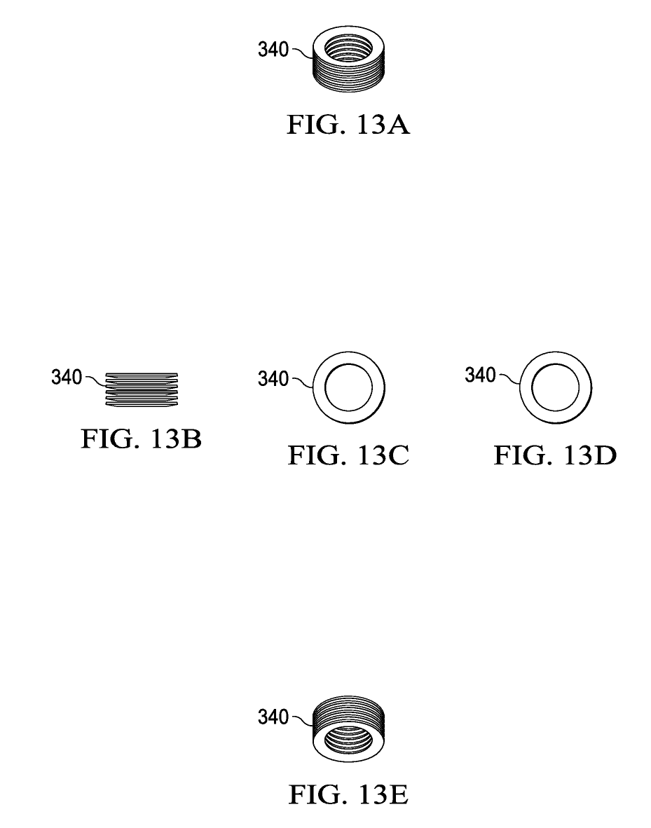

FIG. 13A shows a top-facing perspective view of a plurality of spring washers 340 of a reciprocation-dampening drive shaft assembly 300 in accordance with one or more embodiments of the present invention. Continuing, FIG. 13B shows a side elevation view of the plurality of spring washers 340 of the reciprocation-dampening drive shaft assembly 300 in accordance with one or more embodiments of the present invention. Continuing, FIG. 13C shows a top plan view of the plurality of spring washers 340 of the reciprocation-dampening drive shaft assembly 300 in accordance with one or more embodiments of the present invention. Continuing, FIG. 13D shows a bottom plan view of the plurality of spring washers 340 of the reciprocation-dampening drive shaft assembly 300 in accordance with one or more embodiments of the present invention. Continuing, FIG. 13E shows a bottom-facing perspective view of the plurality of spring washers 340 of the reciprocation-dampening drive shaft assembly 300 in accordance with one or more embodiments of the present invention.

One of ordinary skill in the art will recognize that the number of spring washers 340 used may vary to adjust the spring constant based on an application or design in accordance with one or more embodiments of the present invention. In certain embodiments, the plurality of spring washers 340 may be Belleville washers. In other embodiments, one or more extension springs (not shown) may be used in place of the plurality of spring washers 340. One of ordinary skill in the art will recognize that the type or kind of spring washers 340 used may vary based on an application or design in accordance with one or more embodiments of the present invention.

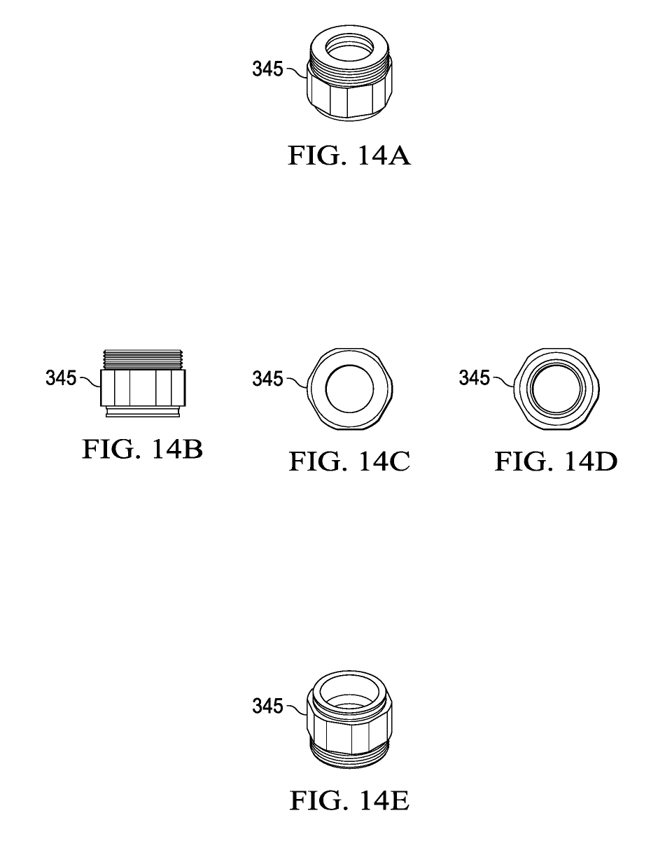

FIG. 14A shows a top-facing perspective view of a reciprocation-dampening adapter cap 345 of a reciprocation-dampening drive shaft assembly 300 in accordance with one or more embodiments of the present invention. Continuing, FIG. 14B shows a side elevation view of the reciprocation-dampening adapter cap 345 of the reciprocation-dampening drive shaft assembly 300 in accordance with one or more embodiments of the present invention. In this view, the adapter cap threaded end as well as the recessed area disposed about its outer surface configured to secure a first end of a boot 355 to the reciprocation-dampening adapter cap 345 is shown. Continuing, FIG. 14C shows a top plan view of the reciprocation-dampening adapter cap 345 of the reciprocation-dampening drive shaft assembly 300 in accordance with one or more embodiments of the present invention. Continuing, FIG. 14D shows a bottom plan view of the reciprocation-dampening adapter cap 345 of the reciprocation-dampening drive shaft assembly 300 in accordance with one or more embodiments of the present invention. Continuing, FIG. 14E shows a bottom-facing perspective view of the reciprocation-dampening adapter cap 345 of the reciprocation-dampening drive shaft assembly 300 in accordance with one or more embodiments of the present invention. One of ordinary skill in the art will recognize that the shape, size, and configuration of reciprocation-dampening adapter cap 345, including the shape of the recessed dampener aperture, may vary based on an application or design in accordance with one or more embodiments of the present invention.

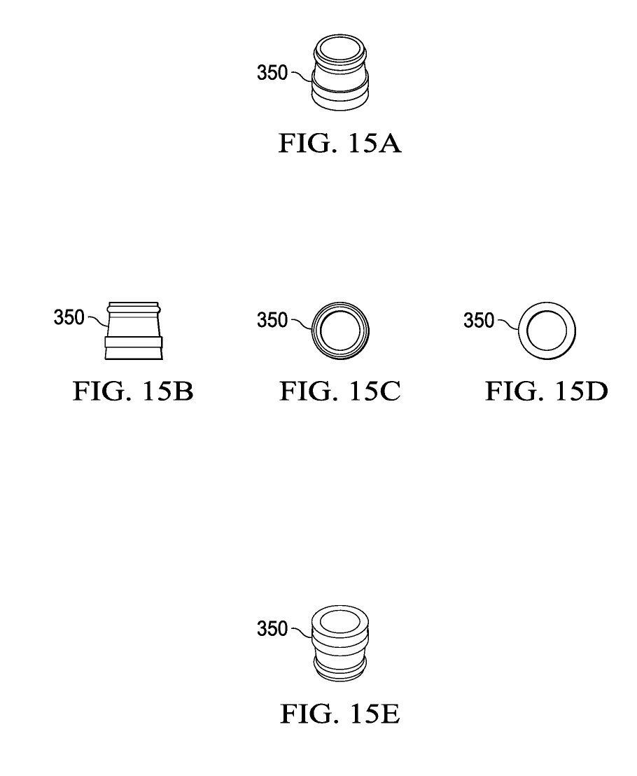

FIG. 15A shows a top-facing perspective view of a dampener insert 350 of a reciprocation-dampening drive shaft assembly 300 in accordance with one or more embodiments of the present invention. Continuing, FIG. 15B shows a side elevation view of the dampener insert 350 of the reciprocation-dampening drive shaft assembly 300 in accordance with one or more embodiments of the present invention. Continuing, FIG. 15C shows a top plan view of the dampener insert 350 of the reciprocation-dampening drive shaft assembly 300 in accordance with one or more embodiments of the present invention. Continuing, FIG. 15D shows a bottom plan view of the dampener insert 350 of the reciprocation-dampening drive shaft assembly 300 in accordance with one or more embodiments of the present invention. Continuing, FIG. 15E shows a bottom-facing perspective view of the dampener insert 350 of the reciprocation-dampening drive shaft assembly 300 in accordance with one or more embodiments of the present invention.

In certain embodiments, dampener insert 350 may be composed of urethane, nitrile, fluorocarbons, butadiene, polymers, elastomers, synthetic rubbers, or combinations thereof. One of ordinary skill in the art will recognize that any other suitable material may be used in in accordance with one or more embodiments of the present invention. One of ordinary skill in the art will also recognize that the shape, size, and configuration of dampener insert 350 may vary based on an application or design in accordance with one or more embodiments of the present invention.

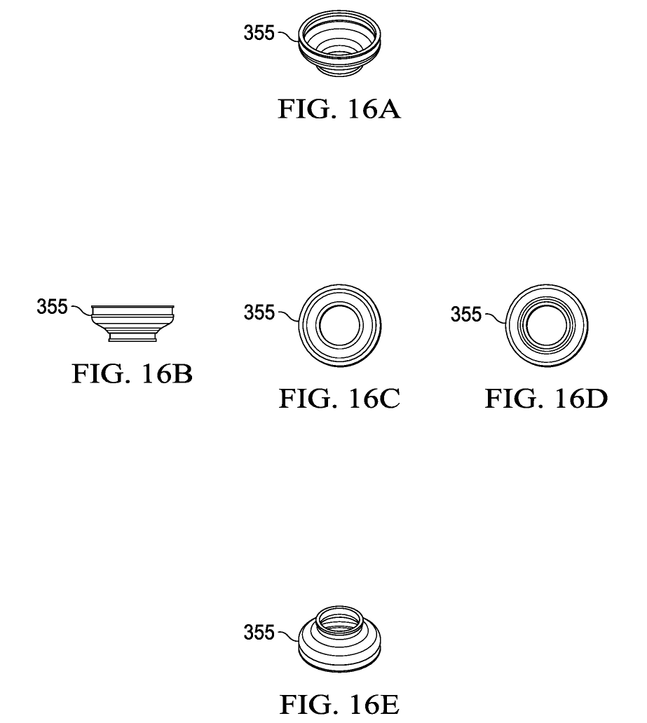

FIG. 16A shows a top-facing perspective view of a boot 355 of a reciprocation-dampening drive shaft assembly 300 in accordance with one or more embodiments of the present invention. Continuing, FIG. 16B shows a side elevation view of the boot 355 of the reciprocation-dampening drive shaft assembly 300 in accordance with one or more embodiments of the present invention. Continuing, FIG. 16C shows a top plan view of the boot 355 of the reciprocation-dampening drive shaft assembly 300 in accordance with one or more embodiments of the present invention. Continuing, FIG. 16D shows a bottom plan view of the boot 355 of the reciprocation-dampening drive shaft assembly 300 in accordance with one or more embodiments of the present invention. Continuing, FIG. 16E shows a bottom-facing perspective view of the boot 355 of the reciprocation-dampening drive shaft assembly 300 in accordance with one or more embodiments of the present invention. In certain embodiments, boot 355 may be composed of hydrogenated nitrile butadiene rubber (“H-NBR”). One of ordinary skill in the art will recognize that the material composition of boot 355 may vary based on an application or design in accordance with one or more embodiments of the present invention. One of ordinary skill in the art will recognize that the shape, size, and configuration of boot 355 may vary based on an application or design in accordance with one or more embodiments of the present invention.

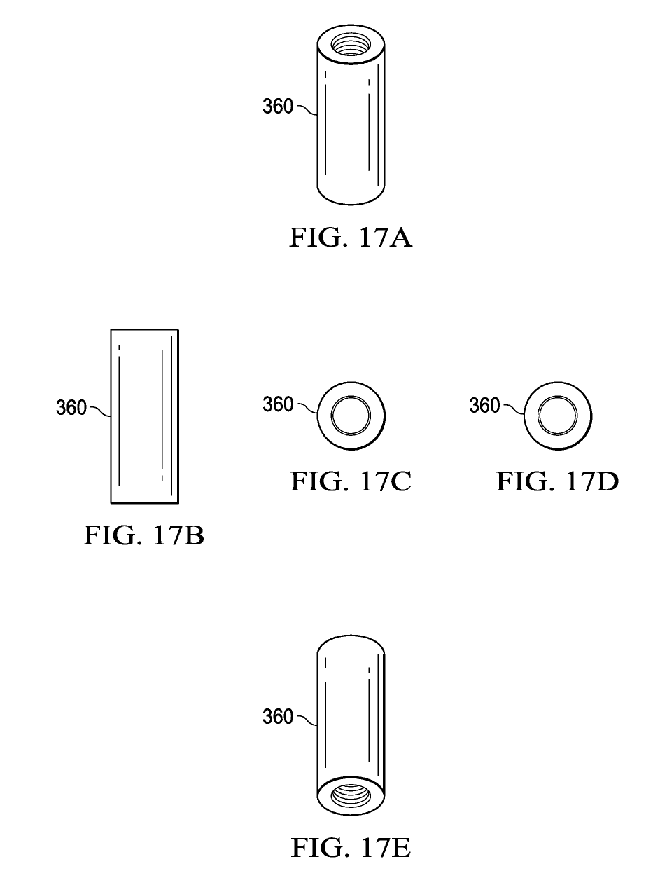

FIG. 17A shows a top-facing perspective view of a drive shaft joint 360 of a reciprocation-dampening drive shaft assembly 300 in accordance with one or more embodiments of the present invention. Continuing, FIG. 17B shows a side elevation view of the drive shaft joint 360 of the reciprocation-dampening drive shaft assembly 300 in accordance with one or more embodiments of the present invention. Continuing, FIG. 17C shows a top plan view of the drive shaft joint 360 of the reciprocation-dampening drive shaft assembly 300 in accordance with one or more embodiments of the present invention. Continuing, FIG. 17D shows a bottom plan view of the drive shaft joint 360 of the reciprocation-dampening drive shaft assembly 300 in accordance with one or more embodiments of the present invention. Continuing, FIG. 17E shows a bottom-facing perspective view of the drive shaft joint 360 of the reciprocation-dampening drive shaft assembly 300 in accordance with one or more embodiments of the present invention. One of ordinary skill in the art will recognize that the shape, size, and configuration of boot 355 may vary based on an application or design in accordance with one or more embodiments of the present invention.

FIG. 18A shows a top-facing perspective view of a second drive shaft portion 325b of a reciprocation-dampening drive shaft assembly 300 in accordance with one or more embodiments of the present invention. Second drive shaft portion 325b may include a spheroidal end, a cylindrical shaft portion 1805, and a shaft threaded end 1110. Cylindrical shaft portion 1805 of the second drive shaft portion 325b may be shorter than, longer than, or substantially equal in length to the cylindrical shaft portion (e.g., 1105 of FIG. 11) of the first drive shaft portion (e.g., 325a of FIG. 1). One of ordinary skill in the art will recognize that the length and diameter of the cylindrical shaft portion 1805 may vary based on an application or design in accordance with one or more embodiments of the present invention. Continuing, FIG. 18B shows a side elevation view of the second drive shaft portion 325b of the reciprocation-dampening drive shaft assembly 300 in accordance with one or more embodiments of the present invention. Continuing, FIG. 18C shows a top plan view of the second drive shaft portion 325b of the reciprocation-dampening drive shaft assembly 300 in accordance with one or more embodiments of the present invention. Continuing, FIG. 18D shows a bottom plan view of the second drive shaft portion 325b of the reciprocation-dampening drive shaft assembly 300 in accordance with one or more embodiments of the present invention. Continuing, FIG. 18E shows a bottom-facing perspective view of the second drive shaft portion 325b of the reciprocation-dampening drive shaft assembly 300 in accordance with one or more embodiments of the present invention. One of ordinary skill in the art will recognize that the shape, size, and configuration of second drive shaft portion 325b may vary based on an application or design in accordance with one or more embodiments of the present invention.

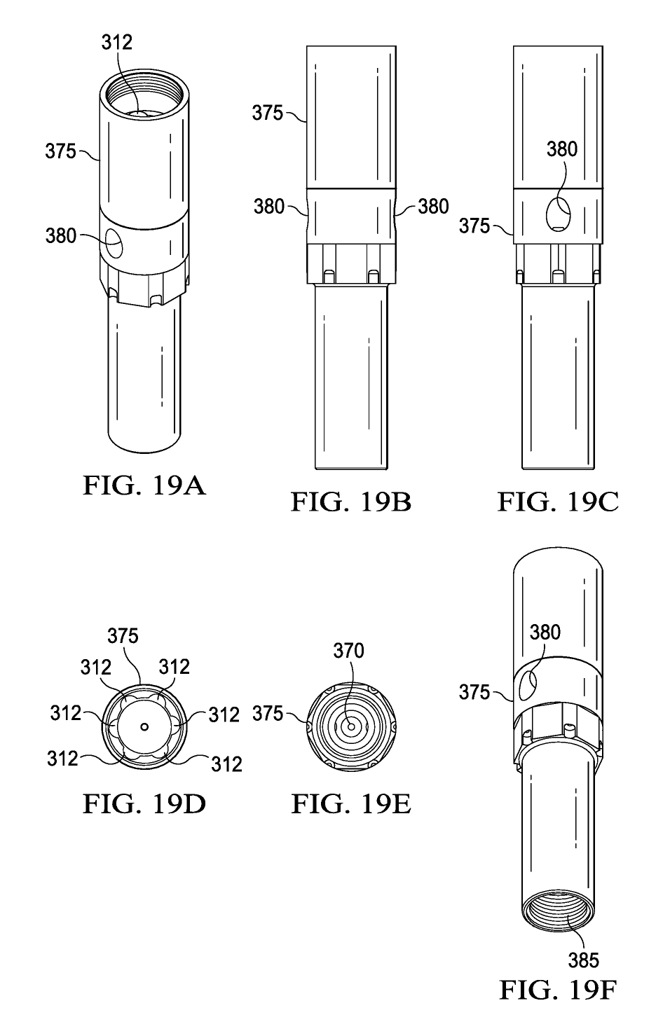

FIG. 19A shows a top-facing perspective view of a second reciprocation-dampening adapter 375 of a reciprocation-dampening drive shaft assembly 300 in accordance with one or more embodiments of the present invention. Continuing, FIG. 19B shows a front elevation view of the second reciprocation-dampening adapter 375 of the reciprocation-dampening drive shaft assembly 300 in accordance with one or more embodiments of the present invention. Continuing, FIG. 19C shows a side elevation view of the second reciprocation-dampening adapter 375 of the reciprocation-dampening drive shaft assembly 300 in accordance with one or more embodiments of the present invention. Continuing, FIG. 19D shows a top plan view of the second reciprocation-dampening adapter 375 of the reciprocation-dampening drive shaft assembly 300 in accordance with one or more embodiments of the present invention. Continuing, FIG. 19E shows a bottom plan view of the second reciprocation-dampening adapter 375 of the reciprocation-dampening drive shaft assembly 300 in accordance with one or more embodiments of the present invention. Continuing, FIG. 19F shows a bottom-facing perspective view of the second reciprocation-dampening adapter 375 of the reciprocation-dampening drive shaft assembly 300 in accordance with one or more embodiments of the present invention. In certain embodiments, second reciprocation-dampening adapter 375 may include an integrated flow diverter 380. In other embodiments, second reciprocation-dampening adapter 375 may connect to a discrete flow diverter (not shown). One of ordinary skill in the art will recognize that the shape, size, and configuration of second reciprocation-dampening adapter 375 may vary based on an application or design in accordance with one or more embodiments of the present invention.

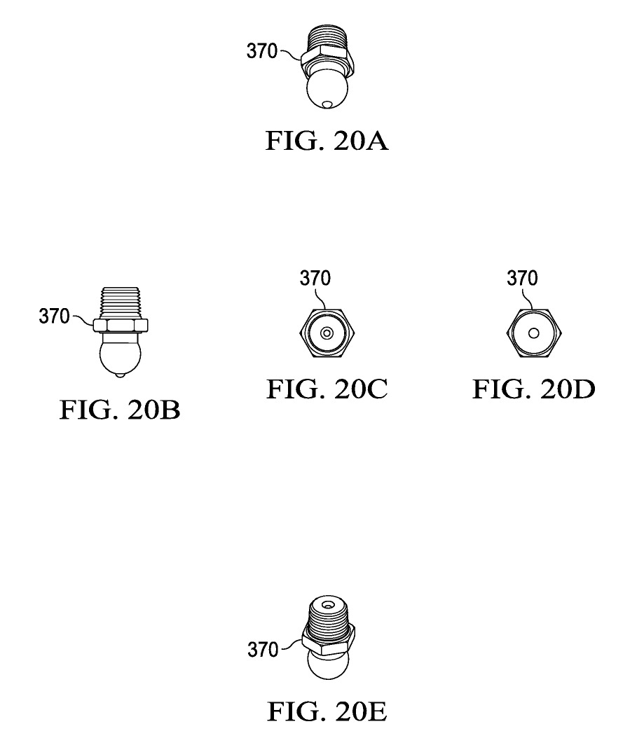

FIG. 20A shows a top-facing perspective view of a grease injection nipple 370 of a reciprocation-dampening drive shaft assembly 300 in accordance with one or more embodiments of the present invention. Continuing, FIG. 20B shows a side elevation view of the grease injection nipple 370 of the reciprocation-dampening drive shaft assembly 300 in accordance with one or more embodiments of the present invention. Continuing, FIG. 20C shows a top plan view of the grease injection nipple 370 of the reciprocation-dampening drive shaft assembly 300 in accordance with one or more embodiments of the present invention. Continuing, FIG. 20D shows a bottom plan view of the grease injection nipple 370 of the reciprocation-dampening drive shaft assembly 300 in accordance with one or more embodiments of the present invention. Continuing, FIG. 20E shows a bottom-facing perspective view of the grease injection nipple 370 of the reciprocation-dampening drive shaft assembly 300 in accordance with one or more embodiments of the present invention. One of ordinary skill in the art will recognize that the shape, size, and configuration of grease injection nipple 370 may vary based on an application or design in accordance with one or more embodiments of the present invention.

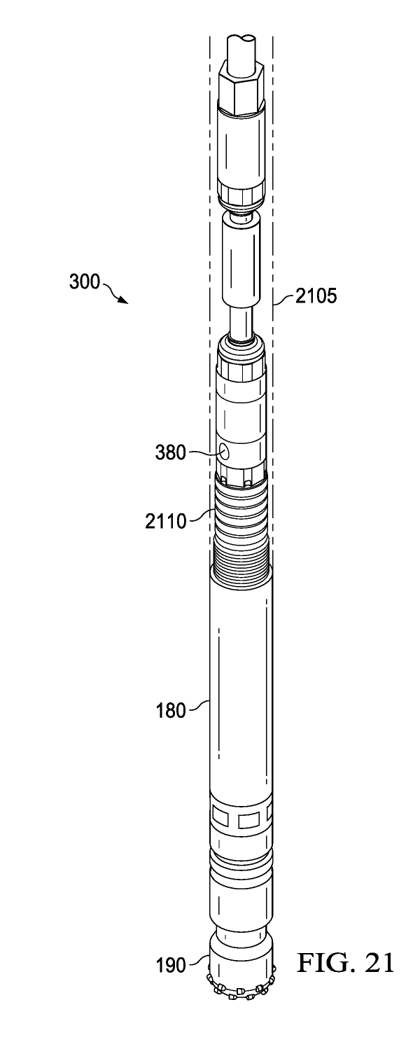

FIG. 21 shows a BHA (e.g., similar to 195 of FIG. 1) including a reciprocation-dampening drive shaft assembly 300 in accordance with one or more embodiments of the present invention. A top portion of reciprocation-dampening drive shaft assembly 300 may be connected to a hydraulic power section (e.g., 150 of FIG. 1) that provides eccentric rotation to the first reciprocation-dampening adapter 310 of the reciprocation-dampening drive shaft assembly 300. The first reciprocation-dampening adapter 310 provides rotation to the first drive shaft portion 325a, which in turn provides rotation to the second drive shaft portion 325b. The second drive shaft portion 325b provides substantially concentric rotation to second reciprocation-dampening adapter 375. For scale, the above-noted components are not independently labeled in this view, but their use is consistent with prior figures. The second reciprocation-dampening adapter 375 may be connected to a bearing assembly 180 and rotate a bearing mandrel (not shown) disposed therein. The bearing assembly 180 may provide rotation to drill bit 190. A cover 2105, shown in ghostline for clarity of disclosure, may be disposed over reciprocation-dampening drive assembly 300 to show that, when fluids are injected downhole, they traverse outside reciprocation-dampening drive shaft assembly 300, but enter fluid injector ports 380 of the second reciprocation-dampening adapter 375. The fluids then pass through an interior passageway 385 of the second reciprocation-dampening adapter 375 and lubricate and cool the bearing assembly 180 and the drill bit 190 during drilling operations.

One of ordinary skill in the art will recognize that the shape, size, and configuration of the various components of reciprocation-dampening drive shaft assembly 300, or its constituent components, may vary based on an application or design in accordance with one or more embodiments of the present invention. Additionally, one of ordinary skill in the art will also recognize that the scale of reciprocation-dampening drive shaft assembly 300, or its constituent components, may also vary based on an application or design in accordance with one or more embodiments of the present invention.

Advantages of one or more embodiments of the present invention may include one or more of the following:

In one or more embodiments of the present invention, a reciprocation-dampening drive shaft assembly can withstand jarring axial loads, as well as vibration, without slippage or damage to the adapters of the drive shaft assembly, thereby extending productive uptime of drilling operations.

In one or more embodiments of the present invention, a reciprocation-dampening drive shaft assembly provides improved operational service life as compared to a conventional drive shaft assembly.

In one or more embodiments of the present invention, a reciprocation-dampening drive shaft assembly may be used in place of a conventional drive shaft assembly.

In one or more embodiments of the present invention, a reciprocation-dampening drive shaft assembly provides at least the same level of performance as that of a conventional drive shaft assembly and in many instances improved performance.

In one or more embodiments of the present invention, a reciprocation-dampening drive shaft assembly reduces the operating cost of a hydraulic drilling system. Conventional drive shaft assemblies are prone to failure. When a conventional drive shaft assembly fails, drilling operations must cease, the BHA must be removed from the wellbore, the drive shaft assembly must be disassembled and consumable parts must be repaired or replaced before it is reassembled and the BHA is redeployed. Because the reciprocation-dampening drive shaft assembly is capable of withstanding jarring axial loads, as well as vibration, the operational service life is increased, nonproductive downtime is reduced, and costs are reduced.

In one or more embodiments of the present invention, a reciprocation-dampening drive shaft assembly provides improved reliability over a conventional drive shaft assembly.

In one or more embodiments of the present invention, a reciprocation-dampening drive shaft assembly is easier to assemble than a conventional drive shaft assembly.

In one or more embodiments of the present invention, a reciprocation-dampening drive shaft assembly is at or near cost parity with a conventional drive shaft assembly.

In one or more embodiments of the present invention, a size of the various components of a reciprocation-dampening drive shaft assembly may vary based on an application or design.

In one or more embodiments of the present invention, a reciprocation-dampening drive shaft assembly may be compatible with hydraulic drilling systems including, for example, a coiled tubing rig.

In one or more embodiments of the present invention, a reciprocation-dampening drive shaft assembly may be compatible with top drive drilling systems.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A reciprocation-dampening drive shaft assembly comprising:
a first reciprocation-dampening adapter comprising a connection end and a cylindrical adapter portion, wherein the cylindrical adapter portion comprises a recessed inner aperture having a first diameter, a recessed inner aperture having a second diameter and a plurality of semispheroidal recessed portions, and a first adapter threaded end;
a first plurality of spring washers disposed within the recessed inner aperture having the first diameter of the first reciprocation-dampening adapter;
a first floating seat disposed within the recessed inner aperture having the first diameter of the first reciprocation-dampening adapter on a spring loaded side of the first plurality of spring washers, wherein the first floating seat comprises a spheroidal cap indentation configured to receive a portion of a spheroidal end of a first drive shaft portion;
the first drive shaft portion comprising the spheroidal end, a cylindrical shaft portion, and a shaft threaded end, wherein the spheroidal end comprises a plurality of ball cap indentations disposed about its outer surface;
a first floating ring comprising a plurality of semispheroidal recessed portions, wherein the plurality of semispheroidal recessed portions of the first dampening adapter are configured to receive a portion of a first plurality of balls partially disposed within the plurality of ball cap indentations of the spheroidal end of the first drive shaft portion and the plurality of semispheroidal recessed portions of the first floating ring are configured to receive a portion of the first plurality of balls partially disposed within the plurality of ball cap indentations of the spheroidal end of the first drive shaft portion;
a first plurality of spring washers disposed within the recessed inner aperture having the second diameter of the first reciprocation-dampening adapter;
a first reciprocation-dampening adapter cap comprising a recessed dampener aperture configured to receive a first dampener insert and a first adapter cap threaded end configured to removably connect to the first adapter threaded end of the first dampening adapter; and
a first boot configured to seal the first reciprocation-dampening adapter cap and the cylindrical shaft portion of the first drive shaft portion.

2. The reciprocation-dampening drive shaft assembly of claim 1, further comprising:
a second reciprocation-dampening adapter comprising a connection end, a cylindrical adapter portion, and a flow diverter portion, wherein the cylindrical adapter portion comprises a recessed inner aperture having the first diameter, a recessed inner aperture having the second diameter and a plurality of semispheroidal recessed portions, and a second adapter threaded end;
a second plurality of spring washers disposed within the recessed inner aperture having the first diameter of the second reciprocation-dampening adapter;
a second floating seat disposed within the recessed inner aperture having the first diameter of the second reciprocation-dampening adapter on a spring loaded side of the second plurality of spring washers, wherein the second floating seat comprises a spheroidal cap indentation configured to receive a portion of a spheroidal end of a second drive shaft portion;
the second drive shaft portion comprising the spheroidal end, a cylindrical shaft portion, and a shaft threaded end, wherein the spheroidal end comprises a plurality of ball cap indentations disposed about its outer surface;
a second floating ring comprising a plurality of semispheroidal recessed portions, wherein the plurality of semispheroidal recessed portions of the second dampening adapter are configured to receive a portion of a second plurality of balls partially disposed within the plurality of ball cap indentations of the spheroidal end of the second drive shaft portion and the plurality of semispheroidal recessed portions of the second floating ring are configured to receive a portion of the second plurality of balls partially disposed within the plurality of ball cap indentations of the spheroidal end of the second drive shaft portion;
a second plurality of spring washers disposed within the recessed inner aperture having the second diameter of the second reciprocation-dampening adapter;
a second reciprocation-dampening adapter cap comprising a recessed dampener aperture configured to receive a second dampener insert and a second adapter cap threaded end configured to removably connect to the second adapter threaded end of the second dampening adapter;
a second boot configured to seal the second reciprocation-dampening adapter cap and the cylindrical shaft portion of the second drive shaft portion.

3. The reciprocation-dampening drive shaft assembly of claim 2, further comprising:
a drive shaft joint having a first distal end configured to receive the shaft threaded end of the first drive shaft portion and a second distal end configured to receive the shaft threaded end of the second drive shaft portion.

4. The reciprocation-dampening drive shaft assembly of claim 2, wherein the cylindrical shaft portion of the second drive shaft portion is longer than the cylindrical shaft portion of the first drive shaft portion.

5. The reciprocation-dampening drive shaft assembly of claim 2, wherein the flow diverter portion comprises a plurality of flow diverter ports configured to divert fluid flow into an interior passageway of the second reciprocation-dampening adapter.

6. The reciprocation-dampening drive shaft assembly of claim 2, wherein the flow diverter portion comprises a grease injection nipple used to inject lubricant into an interior area surrounding the spheroidal end of the second drive shaft portion.

7. The reciprocation-dampening drive shaft assembly of claim 1, wherein the first floating seat comprises a central lumen that fluidly connects the spheroidal end of the first drive shaft portion and the recessed inner aperture having the first diameter of the first reciprocation-dampening adapter.

8. The reciprocation-dampening drive shaft assembly of claim 2, wherein the second floating seat comprises a central lumen that fluidly connects the spheroidal end of the second drive shaft portion and the recessed inner aperture having the first diameter of the second reciprocation-dampening adapter.

9. The reciprocation-dampening drive shaft assembly of claim 1, wherein the recessed dampener aperture of the first reciprocation-dampening adapter cap is tapered toward the first adapter cap threaded end and includes a plurality of ridges configured to secure the first dampener insert within the first reciprocation-dampening adapter cap.

10. The reciprocation-dampening drive shaft assembly of claim 2, wherein the recessed dampener aperture of the second reciprocation-dampening adapter cap is tapered toward the second adapter cap threaded end and includes a plurality of ridges configured to secure the second dampener insert within the second reciprocation-dampening adapter cap.

11. The reciprocation-dampening drive shaft assembly of claim 1, wherein the first dampener insert is composed of urethane, nitrile, fluorocarbons, butadiene, polymers, elastomers, synthetic rubbers, or combinations thereof.

12. The reciprocation-dampening drive shaft assembly of claim 2, wherein the second dampener insert is composed of urethane, nitrile, fluorocarbons, butadiene, polymers, elastomers, synthetic rubbers, or combinations thereof.

13. The reciprocation-dampening drive shaft assembly of claim 1, wherein the first reciprocation-dampening adapter cap comprises a recessed area disposed about its outer surface configured to secure a first end of the first boot to the first reciprocation-dampening adapter cap.

14. The reciprocation-dampening drive shaft assembly of claim 2, wherein the second reciprocation-dampening adapter cap comprises a recessed area disposed about its outer surface configured to secure a first end of the second boot to the second reciprocation-dampening adapter cap.

15. The reciprocation-dampening drive shaft assembly of claim 1, wherein the connection end of the first reciprocation-dampening adapter cap connects to a hydraulic power section.

16. The reciprocation-dampening drive shaft assembly of claim 2, wherein the connection end of the second reciprocation-dampening adapter cap connects to a bearing assembly.

17. The reciprocation-dampening drive shaft assembly of claim 1, wherein the first plurality of spring washers disposed within the recessed inner aperture having the first diameter of the first reciprocation-dampening adapter are Belleville washers.

18. The reciprocation-dampening drive shaft assembly of claim 2, wherein the second plurality of spring washers disposed within the recessed inner aperture having the first diameter of the second reciprocation-dampening adapter are Belleville washers.

19. The reciprocation-dampening drive shaft assembly of claim 1, wherein the first plurality of spring washers disposed within the recessed inner aperture having the second diameter of the first reciprocation-dampening adapter are Belleville washers.

20. The reciprocation-dampening drive shaft assembly of claim 2, wherein the second plurality of spring washers disposed within the recessed inner aperture having the second diameter of the second reciprocation-dampening adapter are Belleville washers.
